(19) United States
(12) Patent Application Publication
(10) Pub. No.: US 2025/0374920 A1
(43) Pub. Date: Dec. 11, 2025

(54) HERBICIDAL COMPOSITION COMPRISING ALKYL POLYGLYCOSIDES

(71) Applicant: BASF SE, Ludwigshafen Am Rhein (DE)

(72) Inventors: Shenghao HU, Shanghai (CN); Yue SHEN, Shanghai (CN); Frederic BAUER, Ludwigshafen am Rhein (DE); Mingjie MAO, Shanghai (CN)

(21) Appl. No.: 18/876,949

(22) PCT Filed: Jul. 26, 2023
(86) PCT No.: PCT/CN2023/109372

§ 371 Date: Dec. 19, 2024

(30) Foreign Application Priority Data
Jul. 27, 2022 (WO) PCT/CN2022/108260

(51) Int. Cl. A01N 25/10; A01N 37/38; A01N 37/40; A01N 43/40; A01N 47/24; A01N 57/20; A01P 13/00

(52) U.S. Cl. CPC A01N 25/10; A01N 37/38; A01N 37/40; A01N 43/40; A01N 47/24; A01N 57/20; A01P 13/00

(57) ABSTRACT

Described herein is a herbicidal composition including a herbicide component and an alkyl polyglycoside (APG) component. The herbicidal composition has a good stability without the need for C₁₂-C₁₆-alkyl ether sulfates and has a low viscosity and low foaming desired for handling during preparation and application.

### FIELD OF THE INVENTION

The present invention generally relates to a herbicidal composition, and more specifically to a herbicidal composition comprising a herbicide component and an alkyl polyglycoside (APG) component.

### BACKGROUND ART

A wide range of herbicidal compositions are known. One problem of herbicidal compositions is their storage stability, especially in the presence of high concentrations of salts.

Alkyl ether sulfates have been used as a surfactant or synergist for herbicidal compositions.

In U.S. Pat. No. 8,445,406 B2, some sodium lauryl ether sulfates (SLES) were added in an amount ranging from 3 to 35% by weight to increase the stability of such aqueous herbicidal compositions including high concentrations of glufosinate or glufosinate salts.

However, sodium lauryl ether sulfates can increase undesirable foaming characteristics of the glufosinate in aqueous herbicidal compositions including high concentrations of glufosinate or glufosinate salts. In addition, sodium lauryl ether sulfates are generally viscous and can result in high viscosity of such compositions, which will be difficult to dilute and thus is generally undesirable from handling during production and application perspectives.

U.S. Pat. No. 8,901,041 B2 discloses a low-foam liquid aqueous herbicidal composition comprising one or more water-soluble herbicidal active ingredients, anionic surfactants and silicone-based defoamers.

US 2005266999 A1 discloses a liquid aqueous crop protectant composition comprising one or more water-soluble active crop protectant ingredients (type (a) active ingredients), nonionic, cationic, anionic and/or zwitterionic surfactants, nonionic surfactants from the group of the alkylpolyglycosides, and inorganic salts from the group of ammonium salts.

There is a continued need for a herbicidal composition having at least one, preferably all of the advantages including high storage stability, low foaming and low viscosity.

### SUMMARY OF THE INVENTION

It is an object of the present invention to provide a herbicidal composition which could provide good control of grassy weeds and have at least one of high storage stability, low foaming and low viscosity.

It has been found that the object of the present invention can be achieved by a herbicidal composition free of or essentially free of C₁₂-C₁₆-alkyl ether sulfates, comprising: a) a herbicide component, and b) an alkyl polyglycoside (hereinafter to be referred to “APG”) component.

In one aspect, the present invention provides a herbicidal composition free of or essentially free of C₁₂-C₁₆-alkyl ether sulfates, comprising:
a) a herbicide component, and
b) an alkyl polyglycoside component containing an alkyl polyglycoside represented by the formula

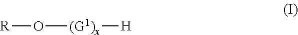

in which
R is a branched alkyl having from 3 to 20 carbon atoms, preferably from 5 to 18 carbons, more preferably from 8 to 13 carbon atoms;
G¹ is a radical resulting from removing a H₂O molecule from a monosaccharide referred to as “reducing sugar”, typically a hexose of formula C₆H₁₂O₆ or a pentose of formula C₅H₁₀O₅; and x represents an average value and is a number within the range of from 1.1 to 10, preferably from 1.1 to 4, more preferably from 1.1 to 2, most preferably from 1.2 to 1.9, especially preferably from 1.2 to 1.6.

In another aspect, the present invention provides a method for preparing the herbicidal composition according to the present invention, comprising mixing the components of the herbicidal composition.

In a further aspect, the present invention provides use of the herbicidal composition according to the present invention for controlling weeds.

It has been surprisingly found that the herbicidal composition comprising a herbicide component and an alkyl polyglycoside component has a good stability without the need for C₁₂-C₁₆-alkyl ether sulfates and has a low viscosity and low foaming desired for handling during preparation and application.

### DETAILED DESCRIPTION OF THE INVENTION

The present invention now will be described in details hereinafter. It is to be understood that the present invention may be embodied in many different ways and shall not be construed as limited to the embodiments set forth herein. Unless mentioned otherwise, all technical and scientific terms used herein have the same meaning as commonly understood by one of ordinary skill in the art to which this invention belongs.

As used herein, the singular forms “a”, “an”, and “the” comprise plural referents unless the context clearly dictates otherwise.

As used herein, the terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

As used herein, the terms “stable” is intended to refer to the compositions that exist in a substantially continuous single phase. An unstable composition, by contrast, does not exist in a substantially continuous single phase. For example, an unstable composition may exhibit varying degrees of phase separations.

As used herein, the term “essentially free of” refers to a small amount lower than an amount at which the component as specified is proposed to use, such as an amount ranging not more than 2% by weight, preferably not more than 1% by weight, more preferably not more than 0.5% by weight, most preferably not more than 0.1% by weight based on the total weight of the composition. For example, as used herein, the term “essentially free of C₁₂-C₁₆-alkyl ether sulfates” refers to herbicidal compositions wherein C₁₂-C₁₆-alkyl ether sulfates are not intentionally added to the herbicidal composition. However, the herbicidal compositions of the present invention may comprise small amounts of C₁₂-C₁₆-alkyl ether sulfates, such as in an amount ranging not more than 2% by weight, preferably not more than 1% by weight, more preferably not more than 0.5% by weight, most preferably not more than 0.1% by weight based on the total weight of the herbicidal composition. Preferably, the herbicidal composition of the present invention is free of C₁₂-C₁₆-alkyl ether sulfates.

Herbicide component a) Within the context of the present invention, suitable herbicides are herbicides from the classes of acetamides, amino acid analogs, amides, aryloxyphenoxypropionates, benzamides, benzofurans, benzoic acids, benzothiadiazinones, bipyridyls, carbamates and thiocarbamates, chloroacetamides, chlorocarboxylic acids, cyclohexanediones, dinitroanilines, dinitrophenols, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazines pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, triazines, triazinones, triazoles, triazolinones, triazolocarboxamides, triazolopyrimidines, triketones, uracils, ureas, including salts thereof, especially ammonium, sodium, potassium or alkyl amine, and combinations thereof.

In some embodiments, suitable herbicides are herbicides from the classes of
acetamides: acetochlor, alachlor, butachlor, dimethachlor, dimethenamid, flufenacet, mefenacet, metolachlor, metazachlor, napropamid, naproanilid, pethoxamid, pretilachlor, propachlor, thenylchlor;
amino acid analogs: bilanafos, glyphosate, glufosinate, sulfosate;
aryloxyphenoxypropionates: clodinafop, cyhalofopbutyl, fenoxaprop, fluazifop, haloxyfop, metamifop, propaquizafop, quizalofop, quizalofop-P-tefuryl;
bipyridyls: diquat, paraquat;
carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate;
phenylcarbamates: mefluidide;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bromoxynil, dichlobenil, ioxynil;
imidazolinones: imazamethabenz, imazamox, imazapic, imazapyr, imazaquin, imazethapyr;
phenoxyacetic acids: clomeprop, 2,4-dichlorophenoxyacetic acid (2,4-D), 2,4-DB, dichlorprop, MCPA, MCPA-thioethyl, MCPB, mecoprop, mecoprop-P;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonylureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuronmethyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propylimidazo[1,2-b]pyridazin-3-yl)sulfonyl)-3-(4,6-dimethoxypyrimidin-2-yl)urea;
triazines: ametryne, atrazine, cyanazine, dimethametryne, ethiozine, hexazinone, metamitron, metribuzine, prometryne, simazine, terbuthylazine, terbutryne, triaziflam, simetryn;
ureas: chlortoluron, daimuron, diuron, fluometuron, isoproturon, linuron, methabenzthiazuron, tebuthiuron;
benzoic acids: dicamba;
benzothiadiazinones: bentazones;
other acetolactate synthase inhibitors: bispyribac-sodium, cloransulam-methyl, diclosulam, florasulam, flucarbazone, flumetsulam, metosulam, orthosulfamuron, penoxsulam, propoxycarbazone, pyribambenz-propyl, pyribenzoxim, pyriftalide, pyriminobac-methyl, pyrimisulfan, pyrithiobac, pyroxasulfon, pyroxsulam;
others: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethyl, chlorthal, cinmethylin, clomazone, cumyluron, cyprosulfamid, difenzoquat, diflufenzopyr, Drechslera monoceras, endothal, ethofumesate, etobenzanid, fentrazamide, flumiclorac-pentyl, flumioxazin, flupoxam, fluorochloridon, flurtamon, indanofan, isoxaben, isoxaflutol, lenacil, propanil, propyzamide, quinclorac, quinmerac, mesotrione, methylarsenic acid, naptalam, oxadiargyl, oxadiazone, oxaziclomefon, pentoxazone, pinoxaden, pyraclonil, pyraflufen-ethyl, pyrasulfotol, pyrazoxyfen, pyrazolynate, quinoclamin, saflufenacil, sulcotrione, sulfentrazone, terbacil, tefuryltrione, tembotrione, thiencarbazone, topramezone, 4 hydroxy-3-[2-(2-methoxyethoxymethyl)-6-trifluoromethylpyridin-3-carbonyl]bicyclo[3.2.1]oct-3-en-2-one, ethyl (3-[2-chloro-4-fluoro-5-(3-methyl-2,6-dioxo-4-trifluoromethyl-3,6-dihydro-2H-pyrimidin-1-yl)phenoxy]pyridin-2-yloxy)acetate, methyl 6 amino-5-chloro-2-cyclopropylpyrimidine-4-carboxylate, 6-chloro-3 (2-cyclopropyl-6-methylphenoxy)pyridazin-4-ol, 4-amino-3-chloro-6-(4-chlorophenyl)-5-fluoropyridin-2-carboxylic acid, methyl 4 amino-3-chloro-6-(4-chloro-2-fluoro-3 methoxyphenyl)pyridin-2-carboxylate and methyl 4-amino-3-chloro-6-(4-chloro-3-dimethylamino-2-fluorophenyl)pyridin-2-carboxylate; including salts thereof, especially ammonium, sodium, potassium or alkyl amine, and combinations thereof.

In some preferred embodiments, suitable herbicides are herbicides from the classes of
amino acid analogs: bilanafos, glyphosate, glufosinate, sulfosate;
carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate;
bipyridyls: diquat, paraquat;
benzothiadiazinones: bentazones;
phenoxyacetic acids: 2,4-dichlorophenoxyacetic acid (2,4-D), 2,4-DB; and
benzoic acids: dicamba;
   including salts thereof, especially ammonium, sodium, potassium or alkyl amine, and combinations thereof.

In some preferred embodiments, suitable herbicides are water-soluble herbicides from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof.

In some particularly preferred embodiments, suitable herbicides are herbicides from the group consisting of glyphosate, glufosinate, asulam, diquat, paraquat, 2,4-D, dicamba, and bentazone, and salts thereof, especially ammonium, sodium, potassium or alkyl amine, and combinations thereof.

In some more particularly preferred embodiments, the herbicidal composition of the present invention comprises glufosinate and/or a salt thereof as its water-soluble herbicide component.

The term “glufosinate”, as defined in the present invention, refers to (RS)-2-amino-4-(hydroxyl(methyl)phosphonoyl)butanoic acid, and specifically is intended to comprise either stereoisomer individually or mixtures thereof (in any relative weight or number ratios), particularly the racemic mixture.

Suitable salts defining the salts of glufosinate may be ammonium, sodium, potassium, alkyl amine, and combinations thereof. Suitable alkyl amines comprise diethylamine and triethylamine.

Ammonium salts that can be used in the present invention have N(R)ₐ⁺ cations wherein R groups, identical or different, represent a hydrogen atom or a linear or non linear, saturated or unsaturated C₁-C₆ hydrocarbon group optionally substituted by a hydroxyl group, for example isopropylamine salts; sulphonium salts; said salts being present alone or in a combination, and mixtures or associations thereof. Ammonium salts that can in particular be cited comprise salts obtained from secondary or primary amines such as isopropylamine (IPA), dimethylamine, diamines such as ethylenediamine, or alkanolamines such as monoethanolamine (MEA). Trimethylsulphonium is a suitable sulphonium salt. Another exemplary glufosinate salt is ammonium salt DL-phosphinothricin ((±)-Ammonium 2-amino-4-(methylphosphinato)butanoate), sometimes simply referred to as glufosinate ammonium.

In some embodiments, the herbicide component a) is present in an amount ranging from 5 to 60% by weight, preferably from 6 to 55% by weight, more preferably from 8 to 50% by weight, most preferably from 9 to 45% by weight, such as from 5 to 10% by weight, such as from 10 to 20% by weight, such as from 20 to 30% by weight, such as from 30 to 40% by weight, such as from 40 to 50% by weight, such as from 50 to 60% by weight, based on the total weight of the herbicidal composition.

In some embodiments, the herbicide component a) as glufosinate is present in an amount ranging from 5 to 35% by weight, preferably from 6 to 30% by weight, more preferably from 8 to 25% by weight, most preferably from 9 to 20% by weight, such as from 5 to 10% by weight, such as from 10 to 20% by weight, such as from 20 to 30% by weight, such as from 30 to 35% by weight, based on the total weight of the herbicidal composition.

### Alkyl Polyglycoside Component b)

Within the context of the present invention, the alkyl polyglycoside (hereinafter to be referred as “APG”) component may contain an alkyl polyglycoside represented by the formula (I)

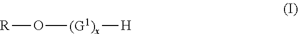

in which 1
R is a branched alkyl having from 3 to 20 carbon atoms, preferably from 5 to 18 carbons, more preferably from 8 to 13 carbon atoms;
G¹ is a radical resulting from removing a H₂O molecule from a monosaccharide referred to as “reducing sugar”, typically a hexose of formula C₆H₁₂O₆ or a pentose of formula C₅H₁₀O₅; and
x represents an average value and is a number within the range of from 1.1 to 10, preferably from 1.1 to 4, more preferably from 1.1 to 2, most preferably from 1.2 to 1.9, especially preferably from 1.2 to 1.6.

As an example of R in the alkyl polyglycoside of the formula (I), it can be 2-ethylhexyl, 2-propylheptyl, 2-butyloctyl, isononyl, isotridecyl, or 5-methyl-2-isopropyl-hexyl. As an example of the reducing sugar resulting in G¹ in the alkyl polyglycoside of the formula (I), it can be at least one selected from the group consisting of rhamnose, glucose, xylose and arabinose. It is preferred that R is 2-ethylhexyl, 2-propylheptyl, 2-butyloctyl, isononyl, isotridecyl, or 5-methyl-2-isopropyl-hexyl and G¹ is a radical resulting from removing a H₂O molecule from rhamnose, glucose, xylose, arabinose or any mixtures thereof, in the alkyl polyglycoside of the formula (I).

In some preferred embodiments of the present invention, the alkyl polyglycoside (I) may be represented by the formula (I-1)

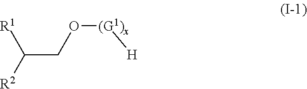

in which
R¹ is a C₁-C₄-alkyl group or hydrogen;
R² is a C₁-C₆-alkyl group or hydrogen;
G¹ is defined as in the formula (I);
x is defined as in the formula (I); and
R¹ and R² are not simultaneously hydrogen, and when one of R¹ and R² is hydrogen, the other of R¹ and R² is a branched alkyl group.

In the formula (I-1), R¹ is a C₁-C₄-alkyl group or hydrogen, for example methyl, ethyl, n-propyl, isopropyl, n-butyl, isobutyl, or sec.-butyl; preferably R¹ is a linear C₁-C₄-alkyl group; even more preferably R¹ is selected from ethyl and n-propyl, most preferably R¹ is selected from ethyl.

Preferably, in the formula (I-1), R² is —CH₂CH₂—R³, wherein R³ is a C₁-C₄-alkyl group or hydrogen; more preferably, R³ is equal to R¹.

It is particularly preferred in the formula (I-1) that the variables R¹ and R² are defined as follows:
R¹ is a C₁-C₄-alkyl group or hydrogen, for example methyl, ethyl, n-propyl, isopropyl, n-butyl, isobutyl, or sec.-butyl, preferably R¹ is linear C₁-C₄-alkyl group, even more preferably R¹ is selected from ethyl and n-propyl; still more preferably R¹ is ethyl; and
R² is —CH₂CH₂—R³, wherein R³ is equal to R¹.

Alkyl polyglycosides represented by the formula (I-1) in which R¹ is selected from ethyl and n-propyl, preferably ethyl, and R² is —CH₂CH₂—R³ with R³ being equal to R¹ may be particularly mentioned. Alkyl polyglycosides represented by the formula (I-1) in which R¹ is ethyl, and R² is —CH₂CH₂—R³ with R³ being equal to R¹ may be particularly preferably mentioned.

In both the formula (I) and the formula (I-1), G¹ represents a radical resulting from removing a H₂O molecule from a monosaccharide referred to as “reducing sugar”. Within the context of the present invention, a reducing sugar refers to a sugar with reductive property, including aldoses and ketoses. Said monosaccharide referred to as reducing sugar suitable for the intended purpose are for example hexose of formula C₆H₁₂O₆ and pentose of formula C₅H₁₀O₅, such as glucose, mannose, galactose, arabinose, xylose, ribose and the like. Also, higher sugars or substituted saccharides which can be hydrolyzed yielding monosaccharides can be used, for example starch, maltose, saccharose, lactose, maltotriose, methyl-, ethyl-, or butyl-glucosides, and so forth.

Alkyl polyglycosides are normally in form of a mixture of various compounds that have different degrees of polymerization of the respective saccharide. In a single molecule only an integer number of G¹ can occur, while the number x is not necessarily an integer. The number x refers to an average value of groups G¹ in a mixture comprising multiple molecules of the formula (I) or the formula (I-1) having an integer number of groups of G¹. The number x may be in the range of from 1.1 to 10, preferably from 1.1 to 4, more preferably from 1.1 to 2 and particularly preferably from 1.2 to 1.9, in particular from 1.2 to 1.6. It is preferred to determine the number x by High Temperature Gas Chromatography (HT-GC).

In a single molecule of the formula (I) or formula (I-1), there may be, for example, only one or two G¹ moieties or up to 15 G¹ moieties per molecule. In a molecule of the formula (I) or the formula (I-1) in which only one group G¹ is comprised, said G¹ is preferably a radical resulting from either glucose or xylose. In a molecule of the formula (I) or formula (I-1) in which two or more G¹ groups are comprised, those G¹ groups may all be preferably radicals resulting from glucose or xylose or combinations of glucose and xylose.

In a single molecule of formula (I) or the formula (I-1) comprising two or more G¹ groups with G¹ being radicals resulting from hexoses such as glucose, the glycosidic bonds between the monosaccharide units may differ in the anomeric configuration (α-; β-) and/or in the position of the linkage, for example in 1,2-position or in 1,3-position and preferably in 1,6-position or 1,4-position.

In some embodiments of the present invention, when G¹ is a radical resulting from glucose, it may contain 0.1 to 0.5% by weight of rhamnose, referring to the total percentage of glucose. In some other embodiments of the present invention, when G¹ is a radical resulting from xylose, it may contain 0.1 to 0.5% by weight of arabinose, referring to the total percentage of xylose.

As said above, alkyl polyglycosides are normally mixtures of various compounds that have a different degree of polymerization of the respective saccharide. It is to be understood that in the formula (I) and formula (I-1), x is a number average value, preferably calculated based on the saccharide distribution determined by high temperature gas chromatography (HTGC), e.g. 400° C., in accordance with K. Hill et al., Alkyl Polyglycosides, VCH Weinheim, New York, Basel, Cambridge, Tokyo, 1997, in particular pages 28 ff., or by HPLC. In HPLC methods, the degree of polymerization may be determined by the Flory method. If the values obtained by HPLC and HTGC are different, preference is given to the values based on HTGC.

In some embodiments of the present invention, the APG may be used in a mixture comprising at least one compound of the formula (I-1) and at least one of its isomers.

Isomers preferably refer to compounds in which the sugar part is identical to G¹ in the formula (I-1) according to the present invention but the alkyl group is different, thus being isomeric to —CH₂CH(R¹)(R²), preferably —CH₂CH(R¹)CH₂CH₂R³, or more preferably —CH₂CH(R¹)CH₂CH₂R¹.

In some embodiments, the APG used according to the present invention comprises at least one compound of the formula (I-1) with the following definitions of the variables, which is designated as component A hereinbelow:
G¹ and x are identical with the respective variables of the respective compound of the formula (I-1) according to the present invention,
R¹ is a C₁-C₄-alkyl group, and
R² is —CH₂CH₂—R¹; and
at least one compound of the formula (I-1) with the following definitions of the variables, which is designated as component B hereinbelow:
G¹ and x are identical with the respective variables of the respective compound of the formula (I-1) according to the present invention,
R¹ is selected from —(CH₂)₂CH₃ or —CH(CH₃)₂ and
R² is selected from —(CH₂)₄CH₃, —(CH₂)₂CH(CH₃)₂, —CH₂CH(CH₃)—CH₂CH₃ and combinations thereof. Preferably, component B may also be a mixture of compounds.

In an embodiment according to the present invention, component B is preferably comprised in the range of from 0.1 to 50% by weight, more preferably in the range of from 0.2 to 30% by weight and particularly preferably 1 to 10% by weight, referring to the total APG, the balance being component A.

An example of isomers in case of alcohol (CH₃)₂CH—(CH₂)₂—CH(iso-C₃H₇)—CH₂—OH, which gives the structure —OCH₂—CH(R¹)(R²) in the formula (I-1), is CH₃—CH(CH₃)—(CH₂)₂—CH(iso-C₃H₇)—CH₂—OH.

The alkyl polyglycoside of the formula (I) as used according to the present invention can be synthesized by conventional methods or commerically available. For the synthesis of the APG, usually one or more monosaccharides referred to as “reducing sugar”, for example one or more selected from glucose and xylose, or the respective di- or polysaccharides are reacted with an alcohol of formula R—OH, wherein R is defined as in the formula (I).

It will be understood that the alkyl polyglycoside component b) may further contain an alkylpolyglycoside having a structure not represented by the formula (I). For example, the alkyl polyglycoside component b) may further contain an alkylpolyglycoside represented by formula of (II),

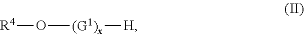

wherein
R⁴ is a linear alkyl having from 3 to 20 carbon atoms, preferably from 5 to 18 carbons, more preferably from 8 to 13 carbon atoms, most preferably from 8 to 10 carbon atoms and
G¹ and x are as defined for the formula (I).

In some embodiments, the alkyl polyglycoside component b) is present in an amount ranging from 0.5 to 40% by weight, preferably from 1 to 35% by weight, more preferably from 1.5 to 30% by weight, most preferably from 1.8 to 25% by weight, such as from 0.5 to 10% by weight, such as from 10 to 20% by weight, such as from 20 to 30% by weight, such as from 30 to 40% by weight, based on the total weight of the herbicidal composition.

In some embodiments, the alkyl polyglycoside component b) is present in an amount ranging from 0.5 to 85% by weight, preferably 0.5 to 75% by weight, still preferably from 1 to 65% by weight, still preferably from 1 to 50% by weight still preferably from 1 to 40% by weight, still preferably from 1 to 35% by weight, more preferably from 1.5 to 30% by weight, most preferably from 1.8 to 25% by weight, such as from 0.5 to 10% by weight, such as from 10 to 20% by weight, such as from 20 to 30% by weight, such as from 30 to 40% by weight, based on the total weight of the herbicidal composition.

In some embodiments, the alkyl polyglycoside component b) contains from 60 to 100% by weight, preferably from 65 to 98% by weight, more preferably from 68 to 95% by weight, most preferably from 70 to 90% by weight, such as from 65 to 70% by weight, such as from 70 to 75% by weight, such as from 75 to 80% by weight, such as from 80 to 85% by weight, such as from 85 to 90% by weight, such as from 90 to 95% by weight, such as from 95 to 100% by weight of alkyl polyglycoside of the formula (I), based on the total weight of the alkyl polyglycoside component b).

In some embodiments, the weight ratio of the herbicide component a) to the alkyl polyglycoside component b) can vary within any range, for example in the range of from 1:500 to 500:1, preferably in the range of from 1:100 to 100:1, more preferably in the range of from 1:50 to 50:1, most preferably in the range of from 1:20 to 20:1, such as in the range of from 1:10 to 10:1, such as in the range of from 1:5 to 5:1, such as in the range of from 1:2 to 2:1.

### Herbicidal Composition

Within the context of the present invention, the herbicidal composition of the present invention is free of or essentially free of C₁₂-C₁₆-alkyl ether sulfates. C₁₂-C₁₆-alkyl ether sulfates are generally defined as salts of sulfated adducts of ethylene oxide with fatty alcohols containing from 12 to 16 carbon atoms. The degree of ethoxylation may be from 1 to 10 moles of ethylene oxide, usually 2 to 4 moles of ethylene oxide. Examples include sodium lauryl ether sulfate, ammonium lauryl ether sulfate, and other salts of lauryl ether sulfate, especially sodium lauryl ether sulfate (SLES). Sodium lauryl ether sulfates are commercially available, typically as an approximate 70% active solution, which may be derived either from vegetable or petroleum sources.

In some embodiments, the herbicidal composition of the present invention is free of or essentially free of C₈-C₁₆-alkyl ether sulfates. C₆-C₁₆-alkyl ether sulfates are generally defined as salts of sulfated adducts of ethylene oxide with fatty alcohols containing from 8 to 16 carbon atoms. The degree of ethoxylation may be from 1 to 10 moles of ethylene oxide, usually 2 to 4 moles of ethylene oxide.

In some embodiments, the herbicidal composition of the present invention is free of or essentially free of alkyl ether sulfates.

The herbicidal composition of the present invention can comprise c) water.

In some embodiments, water is present in an amount ranging from 5 to 85% by weight, preferably from 10 to 84% by weight, more preferably from 20 to 83% by weight, most preferably from 30 to 82% by weight, such as from 10 to 20% by weight, such as from 20 to 30% by weight, such as from 30 to 40% by weight, such as from 40 to 50% by weight, such as from 50 to 60% by weight, such as from 50 to 60% by weight, such as from 60 to 70% by weight, such as from 70 to 80% by weight, such as from 80 to 85% by weight, based on the total weight of the herbicidal composition. The herbicidal composition can be in the form of a soluble concentrate and further diluted with water in a spray tank prior to application at a dilution rate of from 1:50 (one part of herbicidal formulation to 50 parts water) to 1:250 (one part of herbicidal formulation to 250 parts of water).

Some preferred embodiments are described hereinafter in which the herbicidal composition of the present invention is free of or essentially free of C₁₂-C₁₆-alkyl ether sulfates.

In some preferred embodiments, the herbicidal composition of the present invention comprises
a) a herbicide component from the classes of acetamides, amino acid analogs, amides, aryloxyphenoxypropionates, benzamides, benzofurans, benzoic acids, benzothiadiazinones, bipyridyls, carbamates and thiocarbamates, chloroacetamides, chlorocarboxylic acids, cyclohexanediones, dinitroanilines, dinitrophenols, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazines pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, triazines, triazinones, triazoles, triazolinones, triazolocarboxamides, triazolopyrimidines, triketones, uracils, ureas, including salts thereof, especially ammonium, sodium, potassium or alkyl amine, and combinations thereof; and
b) an alkyl polyglycoside component containing an alkyl polyglycoside represented by the formula (I-1)

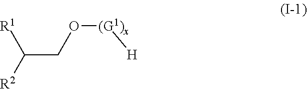

in which
R¹ is a C₁-C₄-alkyl group or hydrogen;
R² is a C₁-C₆-alkyl group or hydrogen;
G¹ is defined as in the formula (I);
x is defined as in the formula (I); and
R¹ and R² are not simultaneously hydrogen, and when one of R¹ and R² is hydrogen, the other of R¹ and R² is a branched alkyl group.

In some preferred embodiments, the herbicidal composition of the present invention comprises
a) a herbicide component from the classes of amino acid analogs, carbamates and thiocarbamates, bipyridyls, bentazones, phenoxyacetic acids, including salts thereof, especially ammonium, sodium, potassium or alkyl amine, and combinations thereof; and
b) an alkyl polyglycoside component containing an alkyl polyglycoside represented by the formula (I-1)

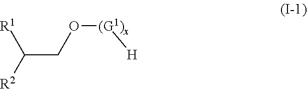

in which
R¹ is a C₁-C₄-alkyl group or hydrogen;
R² is a C₁-C₆-alkyl group or hydrogen;
G¹ is defined as in the formula (I);
x is defined as in the formula (I); and
R¹ and R² are not simultaneously hydrogen, and when one of R¹ and R² is hydrogen, the other of R¹ and R² is a branched alkyl group.

In some preferred embodiments, the herbicidal composition of the present invention comprises
a) a herbicide component from the classes of amino acid analogs, carbamates and thiocarbamates, bipyridyls, bentazones, phenoxyacetic acids, including salts thereof, especially ammonium, sodium, potassium or alkyl amine, and combinations thereof; and
b) an alkyl polyglycoside component containing an alkyl polyglycoside represented by the formula (I-1)

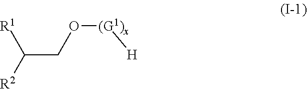

in which
R¹ is a C₁-C₄-alkyl group or hydrogen;
R² is a C₁-C₆-alkyl group or hydrogen;
G¹ is a radical resulting from rhamnose, glucose, xylose, arabinose or any mixtures thereof;
x is in the range of from 1.1 to 10; and
R¹ and R² are not simultaneously hydrogen, and when one of R¹ and R² is hydrogen, the other of R¹ and R² is a branched alkyl group.

In some preferred embodiments, the herbicidal composition of the present invention comprises
a) a herbicide component from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof; and
b) an alkyl polyglycoside component containing an alkyl polyglycoside represented by the formula (I-1)

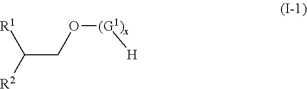

in which
R¹ is a C₁-C₄-alkyl group or hydrogen;
R² is a C₁-C₆-alkyl group or hydrogen;
G¹ is a radical resulting from rhamnose, glucose, xylose, arabinose or any mixtures thereof;
x is in the range of from 1.1 to 10; and
R¹ and R² are not simultaneously hydrogen, and when one of R¹ and R² is hydrogen, the other of R¹ and R² is a branched alkyl group.

In some preferred embodiments, the herbicidal composition of the present invention comprises
a) a herbicide component from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof; and
b) an alkyl polyglycoside component containing an alkyl polyglycoside represented by the formula (I-1)

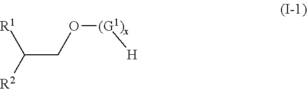

in which
R¹ is methyl, ethyl, n-propyl, isopropyl, n-butyl, isobutyl, or sec.-butyl;
R² is —CH₂CH₂—R³, wherein R³ is a C₁-C₄-alkyl group or hydrogen;
G¹ is a radical resulting from rhamnose, glucose, xylose, arabinose or any mixtures thereof; and
x is in the range of from 1.1 to 10.

In some preferred embodiments, the herbicidal composition of the present invention comprises
a) a herbicide component from the group consisting of glyphosate, glufosinate, asulam, diquat, paraquat, 2,4-D, dicamba, bentazones and salts thereof, and combinations thereof; and
b) an alkyl polyglycoside component containing an alkyl polyglycoside represented by the formula (I-1)

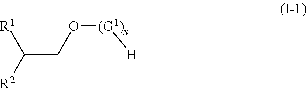

in which
R¹ is methyl, ethyl, n-propyl, isopropyl, n-butyl, isobutyl, or sec.-butyl;
R² is —CH₂CH₂—R³, wherein R³ is a C₁-C₄-alkyl group or hydrogen;
G¹ is a radical resulting from glucose, xylose, arabinose or any mixtures thereof; and
x is in the range of from 1.1 to 4.

In some preferred embodiments, the herbicidal composition of the present invention comprises
a) a herbicide component from the group consisting of glufosinate ammonium, glufosinate-P ammonium, asulam sodium, diquat, paraquat, bentazone sodium, and combinations thereof; and
b) an alkyl polyglycoside component containing an alkyl polyglycoside represented by the formula (I-1)

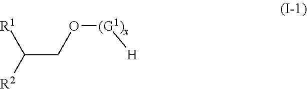

in which
R¹ is ethyl or n-propyl;
R² is —CH₂CH₂—R³, wherein R³ is equal to R¹;
G¹ is a radical resulting from glucose, xylose, or any mixtures thereof; and
x is in the range of from 1.1 to 2.

In some preferred embodiments, the herbicidal composition of the present invention comprises
a) a herbicide component from the group consisting of glufosinate ammonium, glufosinate-P ammonium, asulam sodium, diquat, paraquat, bentazone sodium, and combinations thereof; and
b) an alkyl polyglycoside component containing an alkyl polyglycoside represented by the formula (I-1)

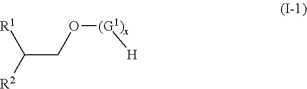

in which
R¹ is ethyl;
R² is —CH₂CH₂—R³, wherein R³ is equal to R¹;
G¹ is a radical resulting from glucose; and
x is in the range of from 1.1 to 2.

In some preferred embodiments, the herbicidal composition of the present invention comprises
a) a herbicide component from the classes of amino acid analogs, carbamates and thiocarbamates, bipyridyls, bentazones, phenoxyacetic acids, including salts thereof, especially ammonium, sodium, potassium or alkyl amine, and combinations thereof; and
b) an alkyl polyglycoside component containing an alkyl polyglycoside represented by the formula (I-1)

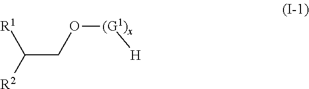

in which
R¹ is a C₁-C₄-alkyl group or hydrogen;
R² is a C₁-C₆-alkyl group or hydrogen;
G¹ is a radical resulting from rhamnose, glucose, xylose, arabinose or any mixtures thereof;
x is in the range of from 1.1 to 10; and
R¹ and R² are not simultaneously hydrogen, and when one of R¹ and R² is hydrogen, the other of R¹ and R² is a branched alkyl group;
wherein the weight ratio of the herbicide component a) to the alkyl polyglycoside component b) is in the range of from 1:500 to 500:1.

In some preferred embodiments, the herbicidal composition of the present invention comprises
a) a herbicide component from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof; and
b) an alkyl polyglycoside component containing an alkyl polyglycoside represented by the formula (I-1)

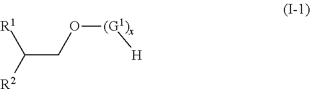

in which
R¹ is a C₁-C₄-alkyl group or hydrogen;
R² is a C₁-C₆-alkyl group or hydrogen;
G¹ is a radical resulting from rhamnose, glucose, xylose, arabinose or any mixtures thereof;
x is in the range of from 1.1 to 10; and
R¹ and R² are not simultaneously hydrogen, and when one of R¹ and R² is hydrogen, the other of R¹ and R² is a branched alkyl group;
wherein the weight ratio of the herbicide component a) to the alkyl polyglycoside component b) is in the range of from 1:100 to 100:1.

In some preferred embodiments, the herbicidal composition of the present invention comprises
a) a herbicide component from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof; and
b) an alkyl polyglycoside component containing an alkyl polyglycoside represented by the formula (I-1)

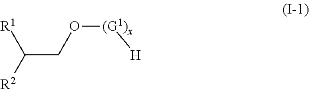

in which
R¹ is methyl, ethyl, n-propyl, isopropyl, n-butyl, isobutyl, or sec.-butyl;
R² is —CH₂CH₂—R³, wherein R³ is a C₁-C₄-alkyl group or hydrogen;
G¹ is a radical resulting from rhamnose, glucose, xylose, arabinose or any mixtures thereof; and
x is in the range of from 1.1 to 10;
wherein the weight ratio of the herbicide component a) to the alkyl polyglycoside component b) is in the range of from 1:50 to 50:1.

In some preferred embodiments, the herbicidal composition of the present invention comprises
a) a herbicide component from the group consisting of glyphosate, glufosinate, asulam, diquat, paraquat, 2,4-D, dicamba, bentazones and salts thereof, and combinations thereof; and
b) an alkyl polyglycoside component containing an alkyl polyglycoside represented by the formula (I-1)

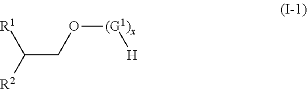

in which
R¹ is methyl, ethyl, n-propyl, isopropyl, n-butyl, isobutyl, or sec.-butyl;
R² is —CH₂CH₂—R³, wherein R³ is a C₁-C₄-alkyl group or hydrogen;
G¹ is a radical resulting from glucose, xylose, arabinose or any mixtures thereof; and
x is in the range of from 1.1 to 4;
wherein the weight ratio of the herbicide component a) to the alkyl polyglycoside component b) is in the range of from 1:20 to 20:1.

In some preferred embodiments, the herbicidal composition of the present invention comprises
a) a herbicide component from the group consisting of glufosinate ammonium, glufosinate-P ammonium, asulam sodium, diquat, paraquat, bentazone sodium, and combinations thereof; and
b) an alkyl polyglycoside component containing an alkyl polyglycoside represented by the formula (I-1)

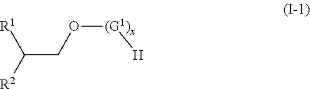

in which
R¹ is ethyl or n-propyl;
R² is —CH₂CH₂—R³, wherein R³ is equal to R¹;
G¹ is a radical resulting from glucose, xylose, or any mixtures thereof; and
x is in the range of from 1.1 to 2;
wherein the weight ratio of the herbicide component a) to the alkyl polyglycoside component b) is in the range of from 1:10 to 10:1.

In some preferred embodiments, the herbicidal composition of the present invention comprises
a) a herbicide component from the group consisting of glufosinate ammonium, glufosinate-P ammonium, asulam sodium, diquat, paraquat, bentazone sodium, and combinations thereof; and
b) an alkyl polyglycoside component containing an alkyl polyglycoside represented by the formula (I-1)

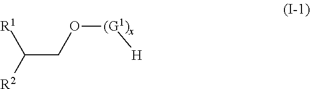

in which
R¹ is ethyl;
R² is —CH₂CH₂—R³, wherein R³ is equal to R¹;
G¹ is a radical resulting from glucose; and
x is in the range of from 1.1 to 2;
wherein the weight ratio of the herbicide component a) to the alkyl polyglycoside component b) is in the range of from 1:10 to 10:1.

In some preferred embodiments, the herbicidal composition of the present invention comprises
a) a herbicide component from the group consisting of glufosinate ammonium, glufosinate-P ammonium, and combinations thereof; and
b) an alkyl polyglycoside component containing an alkyl polyglycoside represented by the formula (I-1)

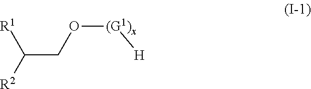

in which
R¹ is ethyl;
R² is —CH₂CH₂—R³, wherein R³ is equal to R¹;
G¹ is a radical resulting from glucose; and
x is in the range of from 1.1 to 2;
wherein the weight ratio of the herbicide component a) to the alkyl polyglycoside component b) is in the range of from 1:5 to 5:1.

In some preferred embodiments, the herbicidal composition of the present invention comprises
a) a herbicide component from the classes of amino acid analogs, carbamates and thiocarbamates, bipyridyls, bentazones, phenoxyacetic acids, including salts thereof, especially ammonium, sodium, potassium or alkyl amine, and combinations thereof; and
b) an alkyl polyglycoside component containing an alkyl polyglycoside represented by the formula (I-1)

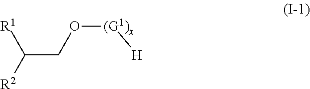

in which
R¹ is a C₁-C₄-alkyl group or hydrogen;
R² is a C₁-C₆-alkyl group or hydrogen;
G¹ is a radical resulting from rhamnose, glucose, xylose, arabinose or any mixtures thereof;
x is in the range of from 1.1 to 10; and
R¹ and R² are not simultaneously hydrogen, and when one of R¹ and R² is hydrogen, the other of R¹ and R² is a branched alkyl group;
and
an alkylpolyglycoside represented by formula of (II),

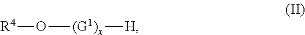

wherein
R⁴ is a linear alkyl having from 3 to 20 carbon atoms, and G¹ and x are as defined for the formula (I-1);
wherein the weight ratio of the herbicide component a) to the alkyl polyglycoside component b) is in the range of from 1:500 to 500:1; and
wherein the alkyl polyglycoside component b) contains from 65 to 98% by weight of alkyl polyglycoside of the formula (I-1), based on the total weight of the alkyl polyglycoside component b).

In some preferred embodiments, the herbicidal composition of the present invention comprises
a) a herbicide component from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof; and
b) an alkyl polyglycoside component containing an alkyl polyglycoside represented by the formula (I-1)

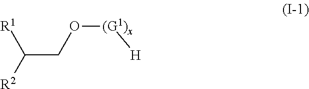

in which
R¹ is a C₁-C₄-alkyl group or hydrogen;
R² is a C₁-C₆-alkyl group or hydrogen;
G¹ is a radical resulting from rhamnose, glucose, xylose, arabinose or any mixtures thereof;
x is in the range of from 1.1 to 10; and
R¹ and R² are not simultaneously hydrogen, and when one of R¹ and R² is hydrogen, the other of R¹ and R² is a branched alkyl group;
and
an alkylpolyglycoside represented by formula of (II),

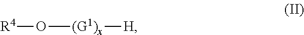

wherein
R⁴ is a linear alkyl having from 5 to 18 carbons, and G¹ and x are as defined for the formula (I-1);
wherein the weight ratio of the herbicide component a) to the alkyl polyglycoside component b) is in the range of from 1:100 to 100:1; and
wherein the alkyl polyglycoside component b) contains from 68 to 95% by weight of alkyl polyglycoside of the formula (I-1), based on the total weight of the alkyl polyglycoside component b).

In some preferred embodiments, the herbicidal composition of the present invention comprises
a) a herbicide component from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof; and
b) an alkyl polyglycoside component containing an alkyl polyglycoside represented by the formula (I-1)

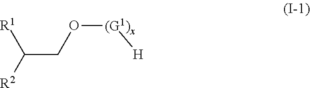

in which
R¹ is methyl, ethyl, n-propyl, isopropyl, n-butyl, isobutyl, or sec.-butyl;
R² is —CH₂CH₂—R³, wherein R³ is a C₁-C₄-alkyl group or hydrogen;
G¹ is a radical resulting from rhamnose, glucose, xylose, arabinose or any mixtures thereof; and
x is in the range of from 1.1 to 10;
and
an alkylpolyglycoside represented by formula of (II),

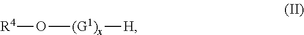

wherein
R⁴ is a linear alkyl having from 8 to 13 carbon atoms, and G¹ and x are as defined for the formula (I-1);
wherein the weight ratio of the herbicide component a) to the alkyl polyglycoside component b) is in the range of from 1:50 to 50:1; and
wherein the alkyl polyglycoside component b) contains from 70 to 90% by weight of alkyl polyglycoside of the formula (I-1), based on the total weight of the alkyl polyglycoside component b).

In some preferred embodiments, the herbicidal composition of the present invention comprises
a) a herbicide component from the group consisting of glyphosate, glufosinate, asulam, diquat, paraquat, 2,4-D, dicamba, bentazones and salts thereof, and combinations thereof; and
b) an alkyl polyglycoside component containing an alkyl polyglycoside represented by the formula (I-1)

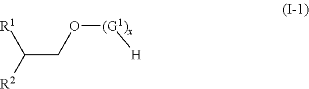

in which
R¹ is methyl, ethyl, n-propyl, isopropyl, n-butyl, isobutyl, or sec.-butyl;
R² is —CH₂CH₂—R³, wherein R³ is a C₁-C₄-alkyl group or hydrogen;
G¹ is a radical resulting from glucose, xylose, arabinose or any mixtures thereof; and
x is in the range of from 1.1 to 4; preferably from 1.1 to 2;
and
an alkylpolyglycoside represented by formula of (II),

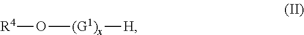

wherein
R⁴ is a linear alkyl having from 8 to 10 carbon atoms, and G¹ and x are as defined for the formula (I-1);
wherein the weight ratio of the herbicide component a) to the alkyl polyglycoside component b) is in the range of from 1:20 to 20:1; and
wherein the alkyl polyglycoside component b) contains from 68 to 95% by weight of alkyl polyglycoside of the formula (I-1), based on the total weight of the alkyl polyglycoside component b).

In some preferred embodiments, the herbicidal composition of the present invention comprises
a) a herbicide component from the group consisting of glufosinate ammonium, glufosinate-P ammonium, asulam sodium, diquat, paraquat, bentazone sodium, and combinations thereof;
and
b) an alkyl polyglycoside component containing an alkyl polyglycoside represented by the formula (I-1)

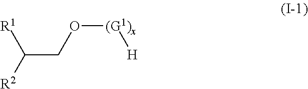

in which
R¹ is ethyl or n-propyl;
R² is —CH₂CH₂—R³, wherein R³ is equal to R¹;
G¹ is a radical resulting from glucose, xylose, or any mixtures thereof; and
x is in the range of from 1.1 to 2;
wherein the weight ratio of the herbicide component a) to the alkyl polyglycoside component b) is in the range of from 1:10 to 10:1; and
wherein the alkyl polyglycoside component b) contains from 70 to 90% by weight of alkyl polyglycoside of the formula (I-1), based on the total weight of the alkyl polyglycoside component b).

In some preferred embodiments, the herbicidal composition of the present invention comprises
a) a herbicide component from the group consisting of glufosinate ammonium, glufosinate-P ammonium, asulam sodium, diquat, paraquat, bentazone sodium, and combinations thereof; and
b) an alkyl polyglycoside component containing an alkyl polyglycoside represented by the formula (I-1)

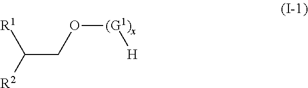

in which
R¹ is ethyl;
R² is —CH₂CH₂—R³, wherein R³ is equal to R¹;
G¹ is a radical resulting from glucose; and
x is in the range of from 1.1 to 2;
wherein the weight ratio of the herbicide component a) to the alkyl polyglycoside component b) is in the range of from 1:10 to 10:1; and
wherein the alkyl polyglycoside component b) contains from 70 to 90% by weight of alkyl polyglycoside of the formula (I-1), based on the total weight of the alkyl polyglycoside component b).

In some preferred embodiments, the herbicidal composition of the present invention comprises
a) a herbicide component from the group consisting of glufosinate ammonium, glufosinate-P ammonium, and combinations thereof; and
b) an alkyl polyglycoside component containing an alkyl polyglycoside represented by the formula (I-1)

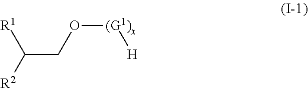

in which
R¹ is ethyl;
R² is —CH₂CH₂—R³, wherein R³ is equal to R¹;
G¹ is a radical resulting from glucose; and
x is in the range of from 1.1 to 2;
wherein the weight ratio of the herbicide component a) to the alkyl polyglycoside component b) is in the range of from 1:5 to 5:1; and
wherein the alkyl polyglycoside component b) contains from 70 to 90% by weight of alkyl polyglycoside of the formula (I-1), based on the total weight of the alkyl polyglycoside component b).

In some preferred embodiments, the herbicidal composition of the present invention comprises
a) a herbicide component from the classes of amino acid analogs, carbamates and thiocarbamates, bipyridyls, bentazones, phenoxyacetic acids, including salts thereof, especially ammonium, sodium, potassium or alkyl amine, and combinations thereof;
b) an alkyl polyglycoside component containing an alkyl polyglycoside represented by the formula (I-1)

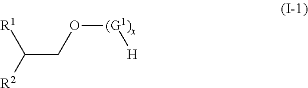

in which
R¹ is a C₁-C₄-alkyl group or hydrogen;
R² is a C₁-C₆-alkyl group or hydrogen;
G¹ is a radical resulting from rhamnose, glucose, xylose, arabinose or any mixtures thereof;
x is in the range of from 1.1 to 10; and
R¹ and R² are not simultaneously hydrogen, and when one of R¹ and R² is hydrogen, the other of R¹ and R² is a branched alkyl group; and
c) water;
wherein the weight ratio of the herbicide component a) to the alkyl polyglycoside component b) is in the range of from 1:500 to 500:1; and
wherein water is present in an amount ranging from 5 to 85% by weight, based on the total weight of the herbicidal composition.

In some preferred embodiments, the herbicidal composition of the present invention comprises
a) a herbicide component from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof;
b) an alkyl polyglycoside component containing an alkyl polyglycoside represented by the formula (I-1)

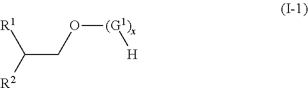

in which
R¹ is a C₁-C₄-alkyl group or hydrogen;
R² is a C₁-C₆-alkyl group or hydrogen;
G¹ is a radical resulting from rhamnose, glucose, xylose, arabinose or any mixtures thereof;
x is in the range of from 1.1 to 10; and
c) water;
R¹ and R² are not simultaneously hydrogen, and when one of R¹ and R² is hydrogen, the other of R¹ and R² is a branched alkyl group;
wherein the weight ratio of the herbicide component a) to the alkyl polyglycoside component b) is in the range of from 1:100 to 100:1; and
wherein water is present in an amount ranging from 10 to 84% by weight, based on the total weight of the herbicidal composition.

In some preferred embodiments, the herbicidal composition of the present invention comprises
a) a herbicide component from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof;
b) an alkyl polyglycoside component containing an alkyl polyglycoside represented by the formula (I-1)

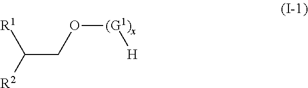

in which
R¹ is methyl, ethyl, n-propyl, isopropyl, n-butyl, isobutyl, or sec.-butyl;
R² is —CH₂CH₂—R³, wherein R³ is a C₁-C₄-alkyl group or hydrogen;
G¹ is a radical resulting from rhamnose, glucose, xylose, arabinose or any mixtures thereof; and
x is in the range of from 1.1 to 10; and
c) water;
wherein the weight ratio of the herbicide component a) to the alkyl polyglycoside component b) is in the range of from 1:50 to 50:1; and
wherein water is present in an amount ranging from 20 to 83% by weight, based on the total weight of the herbicidal composition.

In some preferred embodiments, the herbicidal composition of the present invention comprises
a) a herbicide component from the group consisting of glyphosate, glufosinate, asulam, diquat, paraquat, 2,4-D, dicamba, bentazones and salts thereof, and combinations thereof;
b) an alkyl polyglycoside component containing an alkyl polyglycoside represented by the formula (I-1)

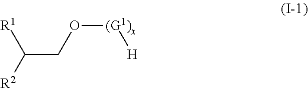

in which
R¹ is methyl, ethyl, n-propyl, isopropyl, n-butyl, isobutyl, or sec.-butyl;
R² is —CH₂CH₂—R³, wherein R³ is a C₁-C₄-alkyl group or hydrogen;
G¹ is a radical resulting from glucose, xylose, arabinose or any mixtures thereof; and
x is in the range of from 1.1 to 4;
wherein the weight ratio of the herbicide component a) to the alkyl polyglycoside component b) is in the range of from 1:20 to 20:1; and
wherein water is present in an amount ranging from 30 to 82% by weight, based on the total weight of the herbicidal composition.

In some preferred embodiments, the herbicidal composition of the present invention comprises
a) a herbicide component from the group consisting of glufosinate ammonium, glufosinate-P ammonium, asulam sodium, diquat, paraquat, bentazone sodium, and combinations thereof;
b) an alkyl polyglycoside component containing an alkyl polyglycoside represented by the formula (I-1)

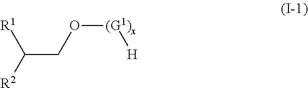

in which
R¹ is ethyl or n-propyl;
R² is —CH₂CH₂—R³, wherein R³ is equal to R¹;
G¹ is a radical resulting from glucose, xylose, or any mixtures thereof; and
x is in the range of from 1.1 to 2; and
c) water;
wherein the weight ratio of the herbicide component a) to the alkyl polyglycoside component b) is in the range of from 1:10 to 10:1; and
wherein water is present in an amount ranging from 5 to 85% by weight, based on the total weight of the herbicidal composition.

In some preferred embodiments, the herbicidal composition of the present invention comprises
a) a herbicide component from the group consisting of glufosinate ammonium, glufosinate-P ammonium, asulam sodium, diquat, paraquat, bentazone sodium, and combinations thereof;
b) an alkyl polyglycoside component containing an alkyl polyglycoside represented by the formula (I-1)

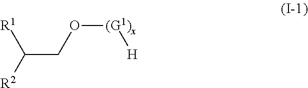

in which
R¹ is ethyl;
R² is —CH₂CH₂—R³, wherein R³ is equal to R¹;
G¹ is a radical resulting from glucose; and
x is in the range of from 1.1 to 2; and
c) water;
wherein the weight ratio of the herbicide component a) to the alkyl polyglycoside component b) is in the range of from 1:10 to 10:1; and
wherein water is present in an amount ranging from 10 to 84% by weight, based on the total weight of the herbicidal composition.

In some preferred embodiments, the herbicidal composition of the present invention comprises
a) a herbicide component from the group consisting of glufosinate ammonium, glufosinate-P ammonium, and combinations thereof;
b) an alkyl polyglycoside component containing an alkyl polyglycoside represented by the formula (I-1)

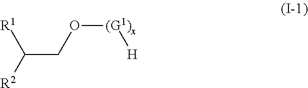

in which
R¹ is ethyl;
R² is —CH₂CH₂—R³, wherein R³ is equal to R¹;
G¹ is a radical resulting from glucose; and
x is in the range of from 1.1 to 2; and
c) water;
wherein the weight ratio of the herbicide component a) to the alkyl polyglycoside component b) is in the range of from 1:5 to 5:1; and
wherein water is present in an amount ranging from 30 to 82% by weight, based on the total weight of the herbicidal composition.

In some preferred embodiments, the herbicidal composition of the present invention comprises
a) a herbicide component from the classes of amino acid analogs, carbamates and thiocarbamates, bipyridyls, bentazones, phenoxyacetic acids, including salts thereof, especially ammonium, sodium, potassium or alkyl amine, and combinations thereof;
b) an alkyl polyglycoside component containing an alkyl polyglycoside represented by the formula (I-1)

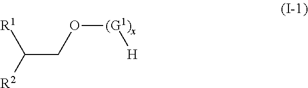

in which
R¹ is a C₁-C₄-alkyl group or hydrogen;
R² is a C₁-C₆-alkyl group or hydrogen;
G¹ is a radical resulting from rhamnose, glucose, xylose, arabinose or any mixtures thereof;
x is in the range of from 1.1 to 10; and
R¹ and R² are not simultaneously hydrogen, and when one of R¹ and R² is hydrogen, the other of R¹ and R² is a branched alkyl group;
and
an alkylpolyglycoside represented by formula of (II),

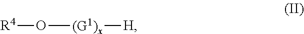

wherein
R⁴ is a linear alkyl having from 3 to 20 carbon atoms, and G¹ and x are as defined for the formula (I-1); and
c) water;
wherein the weight ratio of the herbicide component a) to the alkyl polyglycoside component b) is in the range of from 1:500 to 500:1;
wherein the alkyl polyglycoside component b) contains from 65 to 98% by weight of alkyl polyglycoside of the formula (I-1), based on the total weight of the alkyl polyglycoside component b); and
wherein water is present in an amount ranging from 5 to 85% by weight, based on the total weight of the herbicidal composition.

In some preferred embodiments, the herbicidal composition of the present invention comprises
a) a herbicide component from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof;
b) an alkyl polyglycoside component containing an alkyl polyglycoside represented by the formula (I-1)

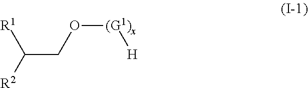

in which
R¹ is a C₁-C₄-alkyl group or hydrogen;
R² is a C₁-C₆-alkyl group or hydrogen;
G¹ is a radical resulting from rhamnose, glucose, xylose, arabinose or any mixtures thereof;
x is in the range of from 1.1 to 10; and
R¹ and R² are not simultaneously hydrogen, and when one of R¹ and R² is hydrogen, the other of R¹ and R² is a branched alkyl group;
and
an alkylpolyglycoside represented by formula of (II),

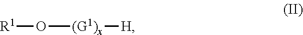

wherein
R⁴ is a linear alkyl having from 5 to 18 carbons, and G¹ and x are as defined for the formula (I-1); and
c) water;
wherein the weight ratio of the herbicide component a) to the alkyl polyglycoside component b) is in the range of from 1:100 to 100:1;
wherein the alkyl polyglycoside component b) contains from 68 to 95% by weight of alkyl polyglycoside of the formula (I-1), based on the total weight of the alkyl polyglycoside component b); and
wherein water is present in an amount ranging from 10 to 84% by weight, based on the total weight of the herbicidal composition.

In some preferred embodiments, the herbicidal composition of the present invention comprises
a) a herbicide component from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof;
b) an alkyl polyglycoside component containing an alkyl polyglycoside represented by the formula (I-1)

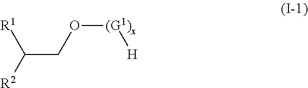

in which
R¹ is methyl, ethyl, n-propyl, isopropyl, n-butyl, isobutyl, or sec.-butyl;
R² is —CH₂CH₂—R³, wherein R³ is a C₁-C₄-alkyl group or hydrogen;
G¹ is a radical resulting from rhamnose, glucose, xylose, arabinose or any mixtures thereof; and
x is in the range of from 1.1 to 10;
and
an alkylpolyglycoside represented by formula of (II),

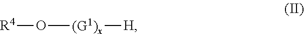

wherein
R⁴ is a linear alkyl having from 8 to 13 carbon atoms, and G¹ and x are as defined for the formula (I-1); and
c) water;
wherein the weight ratio of the herbicide component a) to the alkyl polyglycoside component b) is in the range of from 1:50 to 50:1;
wherein the alkyl polyglycoside component b) contains from 70 to 90% by weight of alkyl polyglycoside of the formula (I-1), based on the total weight of the alkyl polyglycoside component b); and
wherein water is present in an amount ranging from 20 to 83% by weight, based on the total weight of the herbicidal composition.

In some preferred embodiments, the herbicidal composition of the present invention comprises
a) a herbicide component from the group consisting of glyphosate, glufosinate, asulam, diquat, paraquat, 2,4-D, dicamba, bentazones and salts thereof, and combinations thereof;
b) an alkyl polyglycoside component containing an alkyl polyglycoside represented by the formula (I-1)

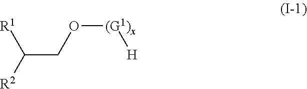

in which
R¹ is methyl, ethyl, n-propyl, isopropyl, n-butyl, isobutyl, or sec.-butyl;
R² is —CH₂CH₂—R³, wherein R³ is a C₁-C₄-alkyl group or hydrogen;
G¹ is a radical resulting from glucose, xylose, arabinose or any mixtures thereof; and
x is in the range of from 1.1 to 4;
and
an alkylpolyglycoside represented by formula of (II),

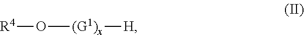

wherein
R⁴ is a linear alkyl having from 8 to 10 carbon atoms, and G¹ and x are as defined for the formula (I-1); and
c) water;
wherein the weight ratio of the herbicide component a) to the alkyl polyglycoside component b) is in the range of from 1:20 to 20:1;
wherein the alkyl polyglycoside component b) contains from 68 to 95% by weight of alkyl polyglycoside of the formula (I-1), based on the total weight of the alkyl polyglycoside component b); and
wherein water is present in an amount ranging from 30 to 82% by weight, based on the total weight of the herbicidal composition.

In some preferred embodiments, the herbicidal composition of the present invention comprises
a) a herbicide component from the group consisting of glufosinate ammonium, glufosinate-P ammonium, asulam sodium, diquat, paraquat, bentazone sodium, and combinations thereof; b) an alkyl polyglycoside component containing an alkyl polyglycoside represented by the formula (I-1)

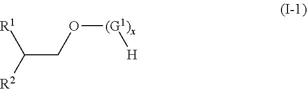

in which
R¹ is ethyl or n-propyl;
R² is —CH₂CH₂—R³, wherein R³ is equal to R¹;
G¹ is a radical resulting from glucose, xylose, or any mixtures thereof; and
x is in the range of from 1.1 to 2;
and
an alkylpolyglycoside represented by formula of (II),

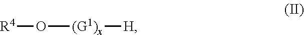

wherein
R⁴ is a linear alkyl having from 5 to 18 carbons, and G¹ and x are as defined for the formula (I-1); and
c) water;
wherein the weight ratio of the herbicide component a) to the alkyl polyglycoside component b) is in the range of from 1:10 to 10:1;
wherein the alkyl polyglycoside component b) contains from 70 to 90% by weight of alkyl polyglycoside of the formula (I-1), based on the total weight of the alkyl polyglycoside component b); and
wherein water is present in an amount ranging from 5 to 85% by weight, based on the total weight of the herbicidal composition.

In some preferred embodiments, the herbicidal composition of the present invention comprises
a) a herbicide component from the group consisting of glufosinate ammonium, glufosinate-P ammonium, asulam sodium, diquat, paraquat, bentazone sodium, and combinations thereof; b) an alkyl polyglycoside component containing an alkyl polyglycoside represented by the formula (I-1)

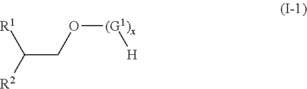

in which
R¹ is ethyl;
R² is —CH₂CH₂—R³, wherein R³ is equal to R¹;
G¹ is a radical resulting from glucose; and
x is in the range of from 1.1 to 2;
and
an alkylpolyglycoside represented by formula of (II),

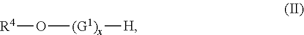

wherein
R⁴ is a linear alkyl having from 8 to 13 carbons, and G¹ and x are as defined for the formula (I-1); and
c) water;
wherein the weight ratio of the herbicide component a) to the alkyl polyglycoside component b) is in the range of from 1:10 to 10:1;
wherein the alkyl polyglycoside component b) contains from 70 to 90% by weight of alkyl polyglycoside of the formula (I-1), based on the total weight of the alkyl polyglycoside component b); and
wherein water is present in an amount ranging from 10 to 84% by weight, based on the total weight of the herbicidal composition.

In some preferred embodiments, the herbicidal composition of the present invention comprises
a) a herbicide component from the group consisting of glufosinate ammonium, glufosinate-P ammonium, and combinations thereof; b) an alkyl polyglycoside component containing an alkyl polyglycoside represented by the formula (I-1)

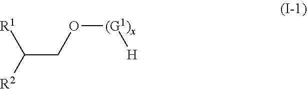

in which
R¹ is ethyl;
R² is —CH₂CH₂—R³, wherein R³ is equal to R¹;
G¹ is a radical resulting from glucose; and
x is in the range of from 1.1 to 2;
and
an alkylpolyglycoside represented by formula of (II),

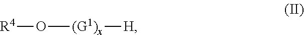

wherein
R⁴ is a linear alkyl having from 8 to 10 carbons, and G¹ and x are as defined for the formula (I-1); and
c) water;
wherein the weight ratio of the herbicide component a) to the alkyl polyglycoside component b) is in the range of from 1:5 to 5:1;
wherein the alkyl polyglycoside component b) contains from 70 to 90% by weight of alkyl polyglycoside of the formula (I-1), based on the total weight of the alkyl polyglycoside component b); and
wherein water is present in an amount ranging from 30 to 82% by weight, based on the total weight of the herbicidal composition.

The herbicidal composition of the present invention can further comprise the solvents other than water, which can be, for example, glycols such as a water-miscible glycol ether; a water-miscible alcohol; a water-miscible ketone; a water-miscible aldehyde; a water-miscible acetate; and any combination (mixture or association) thereof.

Suitable water-miscible glycol ethers that can be used comprise dipropylene glycol, alkylene glycol monoalkyldialkyl ethers such as propylene glycol monomethyl ether, propylene glycol monomethyl ether, propylene glycol monoethyl ether, ethylene glycol monomethyl ether and ethylene glycol monoethyl ether. Suitable water-miscible glycols that can be used comprise dipropylene glycol, propylene glycol, hexylene glycol, ethylene glycol, neopentyl glycol and glycerol. Suitable water-miscible ketones that can be used comprise acetophenone, gamma butyrolactone, N-methyl pyrrolidone. Suitable water-miscible alcohols that can be used comprise such as methanol, ethanol, iso-propanol, furfuryl alcohol, tetrahydrofurfuryl alcohol and methoxy methyl butanol. Suitable water-miscible esters that can be used comprise propylene carbonate. Suitable water-miscible acetates that can be used comprise ethyleneglycol monoacetate. Still further, other solvents that can be used comprise dimethyl formamide; hexadiols; and glycol ether amines.

If comprised, these solvents other than water may be comprised in the herbicidal composition in an amount ranging from 0.1 to 15% by weight, such as from 0.1 to 1% by weight, such as from 1 to 5% by weight, such as from 5 to 10% by weight, such as from 10 to 15% by weight, based on the total weight of the herbicidal composition. In particular, propylene glycol monomethyl ether or similar alkylene glycol monoalkyldialkyl ethers, when comprised, may be used in a range of 0.1 to 10% by weight, such as from 0.1 to 1% by weight, such as from 1 to 5% by weight, such as from 5 to 10% by weight, based upon the total weight of the herbicidal composition.

In some embodiments, the herbicidal composition of the present invention is free of the solvents other than water, for example glycols such as a water-miscible glycol ether, especially propylene glycol monomethyl ether.

The herbicidal composition of the present invention may optionally comprise further auxiliary agents.

Suitable auxiliaries are solid carriers or fillers, surfactants, dispersants, emulsifiers, wetters, solubilizers, penetration enhancers, protective colloids, adhesion agents, thickeners, humectants, repellents, attractants, feeding stimulants, compatibilizers, bactericides, anti-foaming agents, colorants, tackifiers, drift control agents and binders.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate (AMS), ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of phosphates are phosphate esters. Examples of carboxylates are alkyl carboxylates, and carboxylated alcohol or alkylphenol ethoxylates.

Suitable cationic surfactants are quaternary surfactants, for example quaternary ammonium compounds with one or two hydrophobic groups, or salts of long-chain primary amines.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable amphoteric surfactants are alkylbetains and imidazolines.

Suitable thickeners are polysaccharides (e.g. xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable humectants are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants). Suitable tackifiers or binders are polyvinylpyrrolidone, polyvinylacetates, polyvinyl alcohols, polyacrylates, biological or synthetic waxes, and cellulose ethers.

Suitable drift control agents may be understood as chemical agents, which reduce the wind drift when spraying an aqueous tank mix composition. Water soluble polymers, particularly polysaccharide polymers, such as, for example, guar, guar derivatives, and poly(acrylamide) polymers are known to be effective as drift control agents. Other examples of drift control agents are lecithin derivatives, linear nonionic polymers with a molecular weight of at least 20 kDa or fatty alcohol alkoxylates; preferred fatty alcohol alkoxylates are fatty alcohol ethoxylates. The fatty alcohol may comprise a C₁₂₋₂₂, preferably a C₁₄₋₂₀, and in particular a C₁₆₋₁₈ fatty alcohol. The fatty alcohol ethoxylate may comprise from 1 to 15, preferably from 1 to 8, and in particular from 2 to 6 equivalents of ethylene oxide. Especially suitable fatty alcohol ethoxylate is a C₁₄-20 fatty alcohol, which comprises from 2 to 6 equivalents of ethylene oxide.

If comprised, these auxiliary agents may be comprised in the herbicidal composition in an amount ranging from 0.01 to 10% by weight, such as from 0.05 to 1% by weight, such as from 1 to 3% by weight, such as from 3 to 5% by weight, such as from 5 to 7% by weight, such as from 7 to 8.5% by weight, such as from 8.5 to 10% by weight, based on the total weight of the herbicidal composition.

In some embodiments, the herbicidal composition of the present invention is free of anti-foaming agents.

In another aspect, the present invention provides a method for preparing the herbicidal composition according to the present invention, comprising mixing the components of the herbicidal composition.

In a further aspect, the present invention provides the use of the herbicidal composition according to the present invention for controlling harmful plants, especially weeds.

The herbicidal compositions according to the present invention are suitable for controlling a large number of harmful plants, including monocotyledonous weeds, in particular annual weeds such as gramineous weeds (grasses) including Echinochloa species such as barnyardgrass (Echinochloa crusgalli var. crus-galli), Digitaria species such as crabgrass (Digitaria sanguinalis), Setaria species such as green foxtail (Setaria viridis) and giant foxtail (Setaria faberii), Sorghum species such as johnsongrass (Sorghum halepense Pers.), Avena species such as wild oats (Avena fatua), Cenchrus species such as Cenchrus echinatus, Bromus species, Lolium species, Phalaris species, Eriochloa species, Panicum species, Brachiaria species, annual bluegrass (Poa annua), blackgrass (Alopecurus myosuroides), Aegilops cylindrica, Agropyron repens, Apera spica-venti, Eleusine indica, Cynodon dactylon and the like.

The herbicidal compositions according to the present invention are also suitable for controlling a large number of dicotyledonous weeds, in particular broad leaf weeds including Polygonum species such as wild buckwheat (Polygonum convolvolus), Amaranthus species such as pigweed (Amaranthus retroflexus), Chenopodium species such as common lambsquarters (Chenopodium album L.), Sida species such as prickly sida (Sida spinosa L.), Ambrosia species such as common ragweed (Ambrosia artemisiifolia), Acanthospermum species, Anthemis species, Atriplex species, Cirsium species, Convolvulus species, Conyza species, Cassia species, Commelina species, Datura species, Euphorbia species, Geranium species, Galinsoga species, morningglory (Ipomoea species), Lamium species, Malva species, Matricaria species, Sysimbrium species, Solanum species, Xanthium species, Veronica species, Viola species, common chickweed (Stellaria media), velvetleaf (Abutilon theophrasti), Hemp sesbania (Sesbania exaltata Cory), Anoda cristata, Bidens pilosa, Brassica kaber, Capsella bursa-pastoris, Centaurea cyanus, Galeopsis tetrahit, Galium aparine, Helianthus annuus, Desmodium tortuosum, Kochia scoparia, Mercurialis annua, Myosotis arvensis, Papaver rhoeas, Raphanus raphanistrum, Salsola kali, Sinapis arvensis, Sonchus arvensis, Thlaspi arvense, Tagetes minuta, Richardia brasiliensis, and the like. The compositions of the present invention are also suitable for controlling a large number of annual and perennial sedge weeds including Cyperus species such as purple nutsedge (Cyperus rotundus L.), yellow nutsedge (Cyperus esculentus L.), hime-kugu (Cyperus brevifolius H.), sedge weed (Cyperus microiria Steud), rice flatsedge (Cyperus iria L.), and the like.

It has been surprisingly found that the herbicidal composition comprising alkyl polyglycoside has a good stability without the need for C₁₂-C₁₆-alkyl ether sulfates and has a low viscosity and low foaming desired for handling during preparation and application.

The following embodiments and examples are intended to illustrate the invention and are not to be viewed in any way as limiting to the scope of the invention.
Embodiment 1: an herbicidal composition free of or essentially free of C₁₂-C₁₆-alkyl ether sulfates, comprising:
   a) an herbicide component, and
   b) an alkyl polyglycoside component containing an alkyl polyglycoside represented by the formula (I)

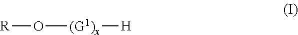

in which
R is a branched alkyl having from 3 to 20 carbon atoms, preferably from 5 to 18 carbons, more preferably from 8 to 13 carbon atoms;
G¹ is a radical resulting from removing a H₂O molecule from a monosaccharide referred to as “reducing sugar”, typically a hexose of formula C₆H₁₂O₆ or a pentose of formula C₅H₁₀O₅; and
x represents an average value and is a number within the range of from 1.1 to 10, preferably from 1.1 to 4, more preferably from 1.1 to 2, most preferably from 1.2 to 1.9, especially preferably from 1.2 to 1.6.
Embodiment 2: The herbicidal composition according to Embodiment 1, wherein the alkyl polyglycoside is represented by the formula (I-1)

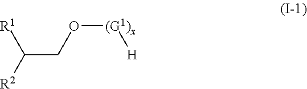

in which
R¹ is a C₁-C₄-alkyl group or hydrogen;
R² is a C₁-C₆-alkyl group or hydrogen;
G¹ is defined as in the formula (I);
x is defined as in the formula (I); and
R¹ and R² are not simultaneously hydrogen, and when one of R¹ and R² is hydrogen, the other of R¹ and R² is a branched alkyl group.
Embodiment 3: The herbicidal composition according to Embodiment 2, wherein R² is —CH₂CH₂—
   R³, wherein R³ is a linear or branched C₁-C₄ alkyl group or hydrogen; preferably, R³ is equal to R¹.
Embodiment 4: The herbicidal composition according to Embodiment 2 or 3, wherein R¹ is methyl, ethyl, n-propyl, isopropyl, n-butyl, isobutyl, or sec.-butyl; preferably ethyl or n-propyl;
   more preferably ethyl.
Embodiment 5: The herbicidal composition according to any one of Embodiments 1 to 4, wherein the monosaccharide referred to as reducing sugar is at least one selected from the group consisting of glucose, mannose, galactose, arabinose, xylose and ribose.
Embodiment 6: The herbicidal composition according to any one of Embodiments 1 to 5, wherein the alkyl polyglycoside is selected from 2-ethylhexyl polyglycoside and 2-propylheptyl polyglycoside, preferably 2-ethylhexyl polyglycoside.
Embodiment 7: The herbicidal composition according to any one of Embodiments 1 to 6, wherein the alkyl polyglycoside component b) further contains an alkylpolyglycoside represented by formula of (II),

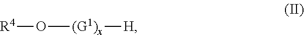

wherein
R⁴ is a linear alkyl having from 3 to 20 carbon atoms, preferably from 5 to 18 carbons, more preferably from 8 to 13 carbon atoms, most preferably from 8 to 10 carbon atoms and
G¹ and x are as defined for the formula (I).
Embodiment 8: The herbicidal composition according to any one of Embodiments 1 to 7, wherein the herbicide is selected from the classes of acetamides, amino acid analogs, amides, aryloxyphenoxypropionates, benzamides, benzofurans, benzoic acids, benzothiadiazinones, bipyridyls, carbamates and thiocarbamates, chloroacetamides, chlorocarboxylic acids, cyclohexanediones, dinitroanilines, dinitrophenols, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazines pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, triazines, triazinones, triazoles, triazolinones, triazolocarboxamides, triazolopyrimidines, triketones, uracils, ureas, including salts thereof, especially ammonium, sodium, potassium or alkyl amine, and combinations thereof.
Embodiment 9: The herbicidal composition according to any one of Embodiments 1 to 8, wherein the herbicide is selected from the classes of
   amino acid analogs: bilanafos, glyphosate, glufosinate, sulfosate;
   carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate;
   bipyridyls: diquat, paraquat;
   benzothiadiazinones: bentazones;
   phenoxyacetic acids: 2,4-dichlorophenoxyacetic acid (2,4-D), 2,4-DB; and
   benzoic acids: dicamba;
   including salts thereof, especially ammonium, sodium, potassium or alkyl amine, and combinations thereof.
Embodiment 10: The herbicidal composition according to any one of Embodiments 1 to 9, wherein the herbicide is selected from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof.
Embodiment 11: The herbicidal composition according to any one of Embodiments 1 to 10, wherein the herbicide is selected from the group consisting of glyphosate, glufosinate, asulam, diquat, paraquat, 2,4-D, dicamba, and bentazones, and salts thereof, especially ammonium, sodium, potassium or alkyl amine, and combinations thereof.
Embodiment 12: The herbicidal composition according to any one of Embodiments 1 to 11, wherein the herbicidal composition is free of or essentially free of C₃-C₆-alkyl ether sulfates, preferably free of C₈-C₁₆-alkyl ether sulfates.
Embodiment 13: The herbicidal composition according to any one of Embodiments 1 to 12, wherein the herbicidal composition is free of or essentially free of alkyl ether sulfates, preferably free of alkyl ether sulfates.
Embodiment 14: The herbicidal composition according to any one of Embodiments 1 to 13, wherein the alkyl polyglycoside component b) is present in an amount ranging from 0.5 to 85% by weight, preferably 0.5 to 75% by weight, still preferably from 1 to 65% by weight, still preferably from 1 to 50% by weight, still preferably from 1 to 40% by weight, more preferably from 1.5 to 30% by weight, most preferably from 1.8 to 25% by weight, such as from 0.5 to 10% by weight, such as from 10 to 20% by weight, such as from 20 to 30% by weight, such as from 30 to 40% by weight, based on the total weight of the herbicidal composition.
Embodiment 15: The herbicidal composition according to any one of Embodiments 1 to 14, wherein the alkyl polyglycoside component b) contains from 60 to 100% by weight, preferably from 65 to 98% by weight, more preferably from 68 to 95% by weight, most preferably from 70 to 90% by weight, such as from 65 to 70% by weight, such as from 70 to 75% by weight, such as from 75 to 80% by weight, such as from 80 to 85% by weight, such as from 85 to 90% by weight, such as from 90 to 95% by weight, such as from 95 to 100% by weight of alkyl polyglycoside of the formula (I), based on the total weight of the alkyl polyglycoside component b).
Embodiment 16: The herbicidal composition according to any one of Embodiments 1 to 15, wherein the weight ratio of the herbicide component a) to the alkyl polyglycoside component b) is in the range of from 1:500 to 500:1, preferably in the range of from 1:100 to 100:1, more preferably in the range of from 1:50 to 50:1, most preferably in the range of from 1:20 to 20:1, such as in the range of from 1:10 to 10:1, such as in the range of from 1:5 to 5:1, such as in the range of from 1:2 to 2:1.
Embodiment 17: A method for preparing the herbicidal composition according to any one of Embodiments 1 to 16, comprising mixing the components of the herbicidal composition.
Embodiment 18: Use of the herbicidal composition according to any one of Embodiments 1 to 16 for controlling harmful plants, especially weeds.

### EXAMPLES

### 1. Materials

### Herbicide:

Glufosinate TK: Glufosinate ammonium TK 30%, from Lier Chemical Co., Ltd.
Glufosinate TC: Glufosinate ammonium TC 95%, from Lier Chemical Co., Ltd.
Glufosinate-P TC: Glufosinate-P ammonium (isomer L-glufosinate, which is active ingredient in glufosinate tech. grade) TC 88.7% from Lier, Chemical Co., Ltd.
Asulam: Asulam sodium 52%, prepared from asulam acid 96% TC, from CAC Nantong Co., Ltd.
Bentazone: bentazone sodium 62% TK, prepared from Bentazone acid, 96% TC, from Zhejiang Tianfeng Co., Ltd.
Diquat: Diquat 40% TK, from Red Sun Co., Ltd.
Paraquat: Paraquat 33.4% TK, from Syngenta Nantong Co., Ltd.

### Alkyl Polyglycoside:

APG-1: 2-ethylhexyl polyglycoside, having an average degree of polymerization of 1.3 to 1.5, 63% active content, commercially available from BASF SE
APG-2: linear C₈-C₁₀-alkyl polyglycoside, having an average degree of polymerization of 1.5, 63% active content, commercially available from BASF SE
APG-3: linear C₈-C₁₀-alkyl polyglycoside, having an average degree of polymerization of 1.5, 53% active content, commercially available from BASF SE
APG-4: linear C₈-C₁₀-alkyl polyglycoside, having an average degree of polymerization of 1.7, 70% active content, commercially available from BASF SE

### Antifoaming Agent:

SAG™ 1572, Silicone antifoam emulsion, 15%, from Momentive

### Solvent:

PM: propylene glycol monomethyl ether, 100%, from Sinopharm
Iso-propanol, 100%, from Sinopharm

### Alkyl Ether Sulfate:

SLES: sodium lauryl ether sulfate, 2EO, 70%, from BASF

### 2. Test Result and Analysis

2.1 Formulation and Test of the Herbicidal Compositions with Glufosinate TK
2.1.1 Formulation of the Herbicidal Compositions with Glufosinate TK

The herbicidal compositions were formulated as follows and the weight percentages of the components and the preparation duration were shown in Table 1, wherein the amount of water represents the sum of individual addition. Shorter preparation duration, more easily mixed for the components.

In Ex.1 to Ex.5 and Comp. Ex.12 without SLES, all components were combined with low shear mixing by magnetic stirring until a homogeneous solution was obtained.

In Comp. Ex.1 to Comp. Ex.11 with SLES, SLES, PM and water were combined, diluted with water by mechanical stirring at 500 rpm, and prepared into a homogeneous solution. Then, all other components were added with low shear mixing at 200 rpm until a homogeneous solution was obtained.

### 2.1.2 Persistent Foam

According to CIPAC MT 47.3, the persistent foam of samples was tested initially and after elevated temperature 54° C. for 2 weeks, as shown in Table 1.

### 2.1.3 Storage Stability and Appearance

The formulations stand until foam shut down, and the initial appearance was inspected. Then, the formulations were divided into 3*30 ml samples for storage stability test under 0° C. for 7 days (according to CIPAC MT 39.3), room temperature (23° C.) for 7 days, and 54° C. for 2 weeks (according to CIPAC MT 46.3), as shown in Table 1.

### 2.1.4 Viscosity

According to CIPAC MT 192, viscosity was measured by rotational viscometry, as shown in Table 1.

TABLE 1

| Components | | | | | | Comp. | Comp. | Comp. | Comp. | Comp. |
|---|---|---|---|---|---|---|---|---|---|---|
| and tests | Ex. 1 | Ex. 2 | Ex. 3 | Ex. 4 | Ex. 5 | Ex. 1 | Ex. 2 | Ex. 3 | Ex. 4 | Ex. 5 |
| Glufosinate | 45 | 45 | 45 | 45 | 45 | 45 | 45 | 45 | 45 | 45 |
| TK | | | | | | | | | | |
| SLES | | | | | | 12.5 | 12.5 | 12.5 | 12.5 | 12.5 |
| PM | | | | | | 7 | | | | 7 |
| Water | 37.3 | 32.3 | 31 | 48.3 | 43.3 | 26.4 | 33.4 | 33.4 | 32.1 | 26.8 |
| Iso-propanol | 3 | 3 | 3 | 3 | 3 | 3 | 3 | 3 | 3 | 3 |
| Glycerin | | | | | 5 | | | | | |
| APG-1 | 14 | 14 | 14 | 3 | 3 | | | 5 | | |
| APG-2 | | 5 | | | | 5 | 5 | | | 5 |
| APG-3 | | | 6.3 | | | | | | 6.3 | |
| APG-4 | | | | | | | | | | |
| Ammonium | 0.7 | 0.7 | 0.7 | 0.7 | 0.7 | 0.7 | 0.7 | 0.7 | 0.7 | 0.7 |
| sulfate | | | | | | | | | | |
| SAG 1572 | | | | | | 0.4 | 0.4 | 0.4 | 0.4 | |
| TOTAL | 100 | 100 | 100 | 100 | 100 | 100 | 100 | 100 | 100 | 100 |
| Prep. | 5 | 5 | 5 | 5 | 5 | 20 | 30 | 30 | 30 | 20 |
| duration | | | | | | | | | | |
| (min) | | | | | | | | | | |
| Appearance | H | H | H | H | H | Gel | Gel | Gel | Gel | Gel |
| initially | | | | | | | | | | |
| Appearance | H | H | H | H | H | H | P | H | P | H |
| under 0° C. | | | | | | | | | | |
| for 7 days | | | | | | | | | | |
| Appearance | H | H | H | H | H | H | P | H | P | H |
| under 23° C. | | | | | | | | | | |
| for 7 days | | | | | | | | | | |
| Appearance | H | H | H | H | H | H | P | H | P | H |
| under 54° C. | | | | | | | | | | |
| for 2 weeks | | | | | | | | | | |
| Persistent | 4 | 6 | — | 1 | 1 | 15 | 8 | 20 | 6 | >105 |
| foam | | | | | | | | | | |
| initially | | | | | | | | | | |
| (ml) | | | | | | | | | | |
| Persistent | 4 | 25 | — | 1 | 1 | 30 | 35 | 30 | 40 | >105 |
| foam after | | | | | | | | | | |
| 54° C. for | | | | | | | | | | |
| 2 weeks | | | | | | | | | | |
| (ml) | | | | | | | | | | |
| Viscosity | 26 | 26 | 20 | 17 | 19 | 42 | 65 | 63 | 60 | 38 |
| (cP) | | | | | | | | | | |

| Components | Comp. | Comp. | Comp. | Comp. | Comp. | Comp. | Comp. |
|---|---|---|---|---|---|---|---|
| and tests | Ex. 6 | Ex. 7 | Ex. 8 | Ex. 9 | Ex. 10 | Ex. 11 | Ex. 12 |
| Glufosinate | 45 | 45 | 45 | 45 | 45 | 45 | 45 |
| TK | | | | | | | |
| SLES | 12.5 | 12.5 | 10.8 | 10.8 | 5.4 | 2.7 | |
| PM | 7 | | | 7 | | | |
| Water | 26.7 | 38.8 | 40.4 | 33.5 | 45.9 | 48.6 | 31.3 |
| Iso-propanol | 3 | 3 | 3 | 3 | 3 | 3 | 3 |
| Glycerin | | | | | | | |
| APG-1 | | | | | | | |
| APG-2 | 5 | | | | | | |
| APG-3 | | | | | | | |
| APG-4 | | | | | | | 20 |
| Ammonium | 0.7 | 0.7 | 0.7 | 0.7 | 0.7 | 0.7 | 0.7 |
| sulfate | | | | | | | |
| SAG 1572 | 0.1 | | 0.1 | | | | |
| TOTAL | 100 | 100 | 100 | 100 | 100 | 100 | 100 |
| Prep. | 20 | 30 | 30 | 20 | 30 | 30 | 5 |
| duration | | | | | | | |
| (min) | | | | | | | |
| Appearance | Gel | Full | P | H | P | P | H |
| initially | | of foam | | | | | |
| Appearance | H | H | F | F | F | F | H |
| under 0° C. | | | | | | | |
| for 7 days | | | | | | | |
| Appearance | H | H | H | H | H | H | H |
| under 23° C. | | | | | | | |
| for 7 days | | | | | | | |
| Appearance | H | P | P | H | P | P | H |
| under 54° C. | | | | | | | |
| for 2 weeks | | | | | | | |
| Persistent | 15 | >105 | 60 | >105 | >105 | >105 | 95 |
| foam | | | | | | | |
| initially | | | | | | | |
| (ml) | | | | | | | |
| Persistent | >105 | >105 | 95 | >105 | >105 | >105 | 105 |
| foam after | | | | | | | |
| 54° C. for | | | | | | | |
| 2 weeks | | | | | | | |
| (ml) | | | | | | | |
| Viscosity | 36 | 74 | 30 | 45 | 21 | 22 | 31 |
| (cP) | | | | | | | |

Ex.: Example;
Comp. Ex.: Comparative Example
H: Homogeneous;
P: Phase separation;
F: Frozen

2.2 Formulation and Test of the Herbicidal Compositions with Glufosinate TC
2.2.1 Formulation of the Herbicidal Compositions with Glufosinate TC

The herbicidal compositions were formulated as follows and the weight percentages of the components and the preparation duration were shown in Table 2, wherein the amount of water represents the sum of individual addition.

In Ex.6 to Ex.8 and Comp. Ex.20 without SLES, Glufosinate TC was dissolved in water and then combined with all other components with low shear mixing by magnetic stirring until a homogeneous solution was obtained.

In Comp. Ex.13 to Comp. Ex.19 with SLES, SLES, PM and water were combined, diluted with water by mechanical stirring at 500 rpm, and prepared into a homogeneous solution. Then, Glufosinate TC was dissolved in water and all other components were added with low shear mixing at 200 rpm until a homogeneous solution was obtained.

### 2.2.2 Persistent Foam

According CIPAC MT 47.3, the persistent foam of samples was tested initially and after elevated temperature 54° C. for 2 weeks, as shown in Table 2.

### 2.2.3 Viscosity

According to CIPAC MT 192, viscosity was measured by rotational viscometry, as shown in Table 2.

TABLE 2

| Components | | | | Comp. | Comp. | Comp. | Comp. | Comp. | Comp. | Comp. | Comp. |
|---|---|---|---|---|---|---|---|---|---|---|---|
| and tests | Ex. 6 | Ex. 7 | Ex. 8 | Ex. 13 | Ex. 14 | Ex. 15 | Ex. 16 | Ex. 17 | Ex. 18 | Ex. 19 | Ex. 20 |
| Glufosinate | 18.75 | 18.75 | 18.75 | 18.75 | 18.75 | 18.75 | 18.75 | 18.75 | 18.75 | 18.75 | 18.75 |
| TC | | | | | | | | | | | |
| SLES | | | | 25 | 25 | 25 | 25 | 25 | 25 | 25 | |
| PM | | | | 7 | | | | 7 | 7 | | |
| Water | 49.55 | 44.55 | 43.25 | 40.15 | 47.15 | 47.15 | 45.85 | 40.55 | 40.45 | 52.55 | 57.55 |
| Iso-propanol | 3 | 3 | 3 | 3 | 3 | 3 | 3 | 3 | 3 | 3 | 3 |
| APG-1 | 28 | 28 | 28 | | | 5 | | | | | |
| APG-2 | | 5 | | 5 | 5 | | | 5 | 5 | | |
| APG-3 | | | 6.3 | | | | 6.3 | | | | |
| APG-4 | | | | | | | | | | | 20 |
| Ammonium | 0.7 | 0.7 | 0.7 | 0.7 | 0.7 | 0.7 | 0.7 | 0.7 | 0.7 | 0.7 | 0.7 |
| sulfate | | | | | | | | | | | |
| SAG 1572 | | | | 0.4 | 0.4 | 0.4 | 0.4 | | 0.1 | | |
| TOTAL | 100 | 100 | 100 | 100 | 100 | 100 | 100 | 100 | 100 | 100 | 100 |
| Prep. | 5 | 5 | 5 | 20 | 30 | 30 | 30 | 20 | 20 | 30 | 20 |
| duration | | | | | | | | | | | |
| (min) | | | | | | | | | | | |
| Persistent | 4 | 10 | — | 15 | 35 | 30 | 45 | >105 | 25 | >105 | 100 |
| foam | | | | | | | | | | | |
| initially | | | | | | | | | | | |
| (ml) | | | | | | | | | | | |
| Persistent | 4 | 10 | — | 45 | 90 | 50 | 60 | >105 | >105 | >105 | 105 |
| foam after | | | | | | | | | | | |
| 54° C. for | | | | | | | | | | | |
| 2 weeks | | | | | | | | | | | |
| (ml) | | | | | | | | | | | |
| Viscosity | 32 | 40 | 40 | 94 | 792 | 722 | 626 | 98 | 98 | 622 | 19 |
| (cP) | | | | | | | | | | | |

Ex.: Example;
Comp. Ex.: Comparative Example

2.3 Formulation and Test of the Herbicidal Compositions with Glufosinate-P TC
2.3.1 Formulation of the Herbicidal Compositions with Glufosinate-P TC

The herbicidal compositions were formulated as follows and the weight percentages of the components and the preparation duration were shown in Table 3, wherein the amount of water represents the sum of individual addition.

In Ex.9 to Ex.11 and Comp. Ex.28 without SLES, Glufosinate-P was dissolved in water and then combined with all other components with low shear mixing by magnetic stirring until a homogeneous solution was obtained.

In Comp. Ex.21 to Comp. Ex.27 with SLES, SLES, PM and water were combined, diluted with water by mechanical stirring at 500 rpm, and prepared into a homogeneous solution. Then, Glufosinate-P TC was dissolved in water and all other components were added with low shear mixing at 200 rpm until a homogeneous solution was obtained.

### 2.3.2 Persistent Foam

According CIPAC MT 47.3, the persistent foam of samples was tested initially and after elevated temperature 54° C. for 2 weeks, as shown in Table 3.

### 2.3.3 Viscosity

According to CIPAC MT 192, viscosity was measured by rotational viscometry, as shown in Table 3.

TABLE 3

| Components | | | | Comp. | Comp. | Comp. | Comp. | Comp. | Comp. | Comp. | Comp. |
|---|---|---|---|---|---|---|---|---|---|---|---|
| and tests | Ex. 9 | Ex. 10 | Ex. 11 | Ex. 21 | Ex. 22 | Ex. 23 | Ex. 24 | Ex. 25 | Ex. 26 | Ex. 27 | Ex. 28 |
| Glufosinate-P | 10.25 | 10.25 | 10.25 | 10.25 | 10.25 | 10.25 | 10.25 | 10.25 | 10.25 | 10.25 | 10.25 |
| TC | | | | | | | | | | | |
| SLES | | | | 25 | 25 | 25 | 25 | 25 | 25 | 25 | |
| PM | | | | 7 | | | | 7 | 7 | | |
| Water | 58.05 | 53.05 | 51.75 | 48.65 | 55.65 | 55.65 | 54.35 | 49.05 | 48.95 | 61.05 | 66.05 |
| Iso-propanol | 3 | 3 | 3 | 3 | 3 | 3 | 3 | 3 | 3 | 3 | 3 |
| APG-1 | 28 | 28 | 28 | | | 5 | | | | | |
| APG-2 | | 5 | | 5 | 5 | | | 5 | 5 | | |
| APG-3 | | | 6.3 | | | | 6.3 | | | | |
| APG-4 | | | | | | | | | | | 20 |
| Ammonium | 0.7 | 0.7 | 0.7 | 0.7 | 0.7 | 0.7 | 0.7 | 0.7 | 0.7 | 0.7 | 0.7 |
| sulfate | | | | | | | | | | | |
| SAG 1572 | | | | 0.4 | 0.4 | 0.4 | 0.4 | | 0.1 | | |
| TOTAL | 100 | 100 | 100 | 100 | 100 | 100 | 100 | 100 | 100 | 100 | 100 |
| Prep. | 5 | 5 | 5 | 20 | 30 | 30 | 30 | 20 | 20 | 30 | 30 |
| duration | | | | | | | | | | | |
| (min) | | | | | | | | | | | |
| Persistent | 4 | 10 | — | 6 | 40 | 15 | 20 | >105 | 25 | >105 | 100 |
| foam | | | | | | | | | | | |
| initially | | | | | | | | | | | |
| (ml) | | | | | | | | | | | |
| Persistent | 4 | 10 | — | 55 | 55 | 30 | 50 | >105 | >105 | >105 | 105 |
| foam after | | | | | | | | | | | |
| 54° C. for | | | | | | | | | | | |
| 2 weeks | | | | | | | | | | | |
| (ml) | | | | | | | | | | | |
| Viscosity | 20 | 24 | 24 | 74 | 5800 | 2472 | 7690 | 72 | 74 | 39360 | 19 |
| (cP) | | | | | | | | | | | |

Ex.: Example;
Comp. Ex.: Comparative Example

2.4 Formulation and Test of the Herbicidal Compositions with Asulam
2.4.1 Formulation of the Herbicidal Compositions with Asulam

The herbicidal compositions were formulated as follows and the weight percentages of the components and the preparation duration were shown in Table 4, wherein the amount of water represents the sum of individual addition.

In Ex.12 to Ex.14 without SLES, all components were combined with low shear mixing by magnetic stirring until a homogeneous solution was obtained.

In Comp. Ex.29 to Comp. Ex.31 with SLES, SLES, PM and water were combined, diluted with water by mechanical stirring at 500 rpm, and prepared into a homogeneous solution. Then, all other components were added with low shear mixing at 200 rpm until a homogeneous solution was obtained.

### 2.4.2 Persistent Foam

According CIPAC MT 47.3, the persistent foam of samples was tested initially and after elevated temperature 54° C. for 2 weeks, as shown in Table 4.

### 2.4.3 Viscosity

According to CIPAC MT 192, viscosity was measured by rotational viscometry, as shown in Table 4.

TABLE 4

| Components | | | | Comp. | Comp. | Comp. |
|---|---|---|---|---|---|---|
| and tests | Ex. 12 | Ex. 13 | Ex. 14 | Ex. 29 | Ex. 30 | Ex. 31 |
| Asulam | 67 | 67 | 67 | 67 | 67 | 67 |
| Glycerin | 5 | 5 | 5 | 5 | 5 | 5 |
| SLES | | | | 18 | 18 | 18 |
| PM | | | | 5 | 5 | |
| Water | 8 | 4.5 | 3.9 | 1.5 | 1.4 | 10 |
| APG-1 | 20 | 20 | 20 | | | |
| APG-2 | | 3.5 | | 3.5 | 3.5 | |
| APG-3 | | | 4.1 | | | |
| SAG 1572 | | | | | 0.1 | |
| TOTAL | 100 | 100 | 100 | 100 | 100 | 100 |
| Prep. | 5 | 5 | 5 | 20 | 20 | 30 |
| duration | | | | | | |
| (min) | | | | | | |
| Persistent | 10 | 15 | — | >105 | >105 | >105 |
| foam | | | | | | |
| initially | | | | | | |
| (ml) | | | | | | |
| Persistent | 10 | 15 | — | >105 | >105 | >105 |
| foam after | | | | | | |
| 54° C. for | | | | | | |
| 2 weeks | | | | | | |
| (ml) | | | | | | |
| Viscosity | 29 | 35 | 33 | 168 | 144 | 923 |
| (cP) | | | | | | |

Ex.: Example;
Comp. Ex.: Comparative Example

2.5 Formulation and Test of the Herbicidal Compositions with Bentazone
2.5.1 Formulation of the Herbicidal Compositions with Bentazone

The herbicidal compositions were formulated as follows and the weight percentages of the components and the preparation duration were shown in Table 5, wherein the amount of water represents the sum of individual addition.

In Ex.15 to Ex.17 without SLES, all components were combined with low shear mixing by magnetic stirring until a homogeneous solution was obtained.

In Comp. Ex.32 to Comp. Ex.34 with SLES, SLES, PM and water were combined, diluted with water by mechanical stirring at 500 rpm, and prepared into a homogeneous solution. Then, all other components were added with low shear mixing at 200 rpm until a homogeneous solution was obtained.

### 2.5.2 Persistent Foam

According CIPAC MT 47.3, the persistent foam of samples was tested initially and after elevated temperature 54° C. for 2 weeks, as shown in Table 5.

### 2.5.3 Viscosity

According to CIPAC MT 192, viscosity was measured by rotational viscometry, as shown in Table 5.

TABLE 5

| Components | | | | Comp. | Comp. | Comp. |
|---|---|---|---|---|---|---|
| and tests | Ex. 15 | Ex. 16 | Ex. 17 | Ex. 32 | Ex. 33 | Ex. 34 |
| Bentazone | 67 | 67 | 67 | 67 | 67 | 67 |
| Glycerin | 5 | 5 | 5 | 5 | 5 | 5 |
| SLES | | | | 18 | 18 | 18 |
| PM | | | | 5 | 5 | |
| Water | 8 | 4.5 | 3.9 | 1.5 | 1.4 | 10 |
| APG-1 | 20 | 20 | 20 | | | |
| APG-2 | | 3.5 | | 3.5 | 3.5 | |
| APG-3 | | | 4.1 | | | |
| SAG 1572 | | | | | 0.1 | |
| TOTAL | 100 | 100 | 100 | 100 | 100 | 100 |
| Prep. | 5 | 5 | 5 | 20 | 20 | 30 |
| duration | | | | | | |
| (min) | | | | | | |
| Persistent | 10 | 15 | — | >105 | >105 | >105 |
| foam | | | | | | |
| initially | | | | | | |
| (ml) | | | | | | |
| Persistent | 8 | 20 | — | >105 | >105 | >105 |
| foam after | | | | | | |
| 54° C. for | | | | | | |
| 2 weeks | | | | | | |
| (ml) | | | | | | |
| Viscosity | 58 | 67 | 62 | 274 | 213 | 97 |
| (cP) | | | | | | |

Ex.: Example;
Comp. Ex.: Comparative Example

2.6 Formulation and Test of the Herbicidal Compositions with Diquat
2.6.1 Formulation of the Herbicidal Compositions with Diquat

The herbicidal compositions were formulated as follows and the weight percentages of the components and the preparation duration were shown in Table 6, wherein the amount of water represents the sum of individual addition.

In Ex.18 to Ex.20 without SLES, all components were combined with low shear mixing by magnetic stirring until a homogeneous solution was obtained.

In Comp. Ex.35 to Comp. Ex.40 with SLES, SLES, PM and water were combined, diluted with water by mechanical stirring at 500 rpm, and prepared into a homogeneous solution. Then, all other components were added with low shear mixing at 200 rpm until a homogeneous solution was obtained.

### 2.6.2 Persistent Foam

According CIPAC MT 47.3, the persistent foam of samples was tested initially and after elevated temperature 54° C. for 2 weeks, as shown in Table 6.

### 2.6.3 Viscosity

According to CIPAC MT 192, viscosity was measured by rotational viscometry, as shown in Table 6.

TABLE 6

| Components | | | | Comp. | Comp. | Comp. | Comp. | Comp. | Comp. |
|---|---|---|---|---|---|---|---|---|---|
| and tests | Ex. 18 | Ex. 19 | Ex. 20 | Ex. 35 | Ex. 36 | Ex. 37 | Ex. 38 | Ex. 39 | Ex. 40 |
| Diquat | 50 | 50 | 50 | 50 | 50 | 50 | 50 | 50 | 50 |
| Glycerin | 7 | 7 | 7 | 7 | 7 | 7 | 7 | 7 | 7 |
| SLES | | | | 25 | 25 | 25 | 25 | 25 | 25 |
| PM | | | | 7 | | | 7 | 7 | |
| Water | 12 | 7 | 5.7 | 2.6 | 9.6 | 8.3 | 3 | 2.8 | 15 |
| Iso-propanol | 3 | 3 | 3 | 3 | 3 | 3 | 3 | 3 | 3 |
| APG-1 | 28 | 28 | 28 | | | | | | |
| APG-2 | | 5 | | 5 | 5 | | 5 | 5 | |
| APG-3 | | | 6.3 | | | 6.3 | | | |
| SAG 1572 | | | | 0.4 | 0.4 | 0.4 | | 0.2 | |
| TOTAL | 100 | 100 | 100 | 100 | 100 | 100 | 100 | 100 | 100 |
| Prep. | 5 | 5 | 5 | 20 | 30 | 30 | 20 | 20 | 30 |
| duration | | | | | | | | | |
| (min) | | | | | | | | | |
| Persistent | 2 | 8 | — | 5 | 15 | 8 | >105 | 10 | >105 |
| foam | | | | | | | | | |
| initially | | | | | | | | | |
| (ml) | | | | | | | | | |
| Persistent | 4 | 6 | — | 15 | 20 | 12 | >105 | 10 | >105 |
| foam after | | | | | | | | | |
| 54° C. for | | | | | | | | | |
| 2 weeks | | | | | | | | | |
| (ml) | | | | | | | | | |
| Viscosity | 20 | 14 | 28 | 98 | 4880 | 8120 | 97 | 101 | 27760 |
| (cP) | | | | | | | | | |

Ex.: Example;
Comp. Ex.: Comparative Example

2.7 Formulation and Test of the Herbicidal Compositions with Paraquat
2.7.1 Formulation of the Herbicidal Compositions with Paraquat

The herbicidal compositions were formulated as follows and the weight percentages of the components and the preparation duration were shown in Table 7, wherein the amount of water represents the sum of individual addition.

In Ex.21 to Ex.23 without SLES, all components were combined with low shear mixing by magnetic stirring until a homogeneous solution was obtained.

In Comp. Ex.41 to Comp. Ex.46 with SLES, SLES, PM and water were combined, diluted with water by mechanical stirring at 500 rpm, and prepared into a homogeneous solution. Then, all other components were added with low shear mixing at 200 rpm until a homogeneous solution was obtained.

### 2.7.2 Persistent Foam

According CIPAC MT 47.3, the persistent foam of samples was tested initially and after elevated temperature 54° C. for 2 weeks, as shown in Table 7.

### 2.7.3 Viscosity

According to CIPAC MT 192, viscosity was measured by rotational viscometry, as shown in Table 7.

TABLE 7

| Components | | | | Comp. | Comp. | Comp. | Comp. | Comp. | Comp. |
|---|---|---|---|---|---|---|---|---|---|
| and tests | Ex. 21 | Ex. 22 | Ex. 23 | Ex. 41 | Ex. 42 | Ex. 43 | Ex. 44 | Ex. 45 | Ex. 46 |
| Paraquat | 49.88 | 49.88 | 49.88 | 49.88 | 49.88 | 49.88 | 49.88 | 49.88 | 49.88 |
| Glycerin | 7 | 7 | 7 | 7 | 7 | 7 | 7 | 7 | 7 |
| SLES | | | | 25 | 25 | 25 | 25 | 25 | 25 |
| PM | | | | 7 | | | 7 | 7 | |
| Water | 12.12 | 7.12 | 5.82 | 2.72 | 9.72 | 8.42 | 3.12 | 2.92 | 15.12 |
| Iso-propanol | 3 | 3 | 3 | 3 | 3 | 3 | 3 | 3 | 3 |
| APG-1 | 28 | 28 | 28 | | | | | | |
| APG-2 | | 5 | | 5 | 5 | | 5 | 5 | |
| APG-3 | | | 6.3 | | | 6.3 | | | |
| SAG 1572 | | | | 0.4 | 0.4 | 0.4 | | 0.2 | |
| TOTAL | 100 | 100 | 100 | 100 | 100 | 100 | 100 | 100 | 100 |
| Prep. | 5 | 5 | 5 | 20 | 30 | 30 | 20 | 20 | 30 |
| duration | | | | | | | | | |
| (min) | | | | | | | | | |
| Persistent | 0 | 0 | — | 0 | 4 | 4 | 85 | 4 | 90 |
| foam | | | | | | | | | |
| initially | | | | | | | | | |
| (ml) | | | | | | | | | |
| Persistent | 0 | 0 | — | 50 | 8 | 8 | >105 | 70 | >105 |
| foam after | | | | | | | | | |
| 54° C. for | | | | | | | | | |
| 2 weeks | | | | | | | | | |
| (ml) | | | | | | | | | |
| Viscosity | 32 | 31 | 28 | 228 | 5050 | 4760 | 235 | 248 | 17080 |
| (cP) | | | | | | | | | |

Ex.: Example;
Comp. Ex.: Comparative Example

### 2.8 Bio Test/Field Trial

2.8.1 Formulation of the Herbicidal Compositions with Glufosinate TC

The herbicidal compositions were formulated as follows and the weight percentages of the components and the preparation duration were shown in Table 8, wherein the amount of water represents the sum of individual addition.

In Ex.24 without SLES, Glufosinate TC was dissolved in water and then combined with all other components with low shear mixing by magnetic stirring until a homogeneous solution was obtained.

In Comp. Ex.47 with SLES, SLES, PM and water were combined, diluted with water by mechanical stirring at 500 rpm, and prepared into a homogeneous solution. Then, Glufosinate TC was dissolved in water and all other components were added with low shear mixing at 200 rpm until a homogeneous solution was obtained.

### 2.8.2 Field Trial

Field trial was conducted on grassy weeds SETVI (short for Setaria viridis from internet CVH): spray vol.: 450 L/ha., plot size: 20 m², number of replicates: 3.

3, 7, 15, 30 days after application (DAA) of the herbicidal composition, investigations were conducted to assay bio performance of samples.

TABLE 8

| Components and tests | Ex. 24 | Comp. Ex. 47 |
|---|---|---|
| Glufosinate TC | 18.75 | 18.75 |
| SLES | | 25 |
| PM | | 7 |
| Water | 53.25 | 49.15 |
| APG-1 | 28 | |
| SAG 1572 | | 0.1 |
| TOTAL | 100 | 100 |
| Control, 3 DAA | 30% | 30% |
| Control, 7 DAA | 94% | 91% |
| Control, 15 DAA | 93% | 90% |
| Control, 30 DAA | 75% | 70% |

Ex.: Example;
Comp. Ex.: Comparative Example

### High Concentrations of Alkyl Polyglycoside in Glufosinate Formulation

### Materials and Methods

Glufosinate ammonium TC 95%, from Lier Chemical Co., Ltd
Break-thru S 200, S 240, S233, Alkoxylate Trisiloxane surfactant, from Evonik
Lutensit A-BO, Sodium dioctylsulphosuccinate, from BASF

### Test Results and Analysis

The test results are shown in Table 9.

### Preparation of Samples

Preparation method refers to the details as described in Table 3.1.1.

TABLE 9

| Components | | | | | | | | |
|---|---|---|---|---|---|---|---|---|
| & Test | Comp. | | | | | | | |
| parameter | Ex. 48 | Ex. 25 | Ex. 26 | Ex. 27 | Ex. 27 | Ex. 28 | Ex. 29 | Ex. 30 |
| glufosinate | 18.75 | 18.75 | 18.75 | 18.75 | 18.75 | 18.75 | 18.75 | 18.75 |
| TC | | | | | | | | |
| SLES | 25 | | | | | | | |
| PM | 7 | | | | | | | |
| water | 45.6 | 50.7 | 50.7 | 50.7 | 48.4 | 49.8 | 27.6 | 2.6 |
| iso-propanol | 3 | 3 | 3 | 3 | 3 | 3 | 3 | 3 |
| Break-thru | | 1.3 | | | | | | |
| S 240 | | | | | | | | |
| Break-thru | | | 1.3 | | | | | |
| S 200 | | | | | | | | |
| Break-thru | | | | 1.3 | | | | |
| S 233 | | | | | | | | |
| Lutensit | | | | | 1.5 | | | |
| A-BO | | | | | | | | |
| APG 1 | | 25.6 | 25.6 | 25.6 | 27.7 | 27.8 | 50.0 | 75.0 |
| ammonium | 0.7 | 0.7 | 0.7 | 0.7 | 0.7 | 0.7 | 0.7 | 0.7 |
| sulfate | | | | | | | | |
| TOTAL | 100 | 100 | 100 | 100 | 100 | 100 | 100 | 100 |
| Prep. | 30 | 5 | 5 | 5 | 5 | 5 | 5 | 5 |
| duration | | | | | | | | |
| (min) | | | | | | | | |
| Viscosity | 94 | 10 | 10 | 10 | 10 | 10 | 50 | 540 |
| (cP) | | | | | | | | |
| Stability* | homo- | homo- | homo- | homo- | homo- | homo- | homo- | homo- |
| RT/CT/HT | geneous | geneous | geneous | geneous | geneous | geneous | geneous | geneous |
| Persistent | 105 ml | 30 ml | 60 ml | 50 ml | 5 ml | 10 ml | 5 ml | 10 ml |
| foam | | | | | | | | |
| initially | | | | | | | | |
| (ml) | | | | | | | | |
| Persistent | 105 ml | 50 ml | 60 ml | 50 ml | 5 ml | 10 ml | 10 ml | 10 ml |
| foam at | | | | | | | | |
| 54° C. | | | | | | | | |
| for 2 weeks | | | | | | | | |
| (ml) | | | | | | | | |

*RT: Room Temperature; CT: Cold Temperature; HT: Hot Temperature APG-1: 2-ethylhexyl polyglycoside, having an average degree of polymerization of 1.3 to 1.5, 63% active content, commercially available from BASF SE

### Storage Stability and Appearance

Standing the final samples until foam shutting down, inspecting its appearance in initial samples; then dividing into 3*30 ml samples for storage stability test under 0° C. for 7 days, room temperature 23° C. and 54° C. for 2 weeks.

### Persistent Foam

According CIPAC MT 37.2, the persistent foam of samples tested.

All the Inventive Examples generate lower foam initially and at 54° C. for 2 weeks.

1. An herbicidal composition free of or essentially free of C₁₂-C₁₆-alkyl ether sulfates, comprising:
a) an herbicide component, and
b) an alkyl polyglycoside component containing an alkyl polyglycoside represented by the formula (I) 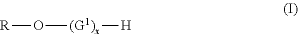
in which
R is a branched alkyl having from 3 to 20 carbon atoms;
G¹ is a radical resulting from removing a H₂O molecule from a monosaccharide, referred to as reducing sugar; and
x represents an average value and is a number within the range of from 1.1 to 10.

2. The herbicidal composition according to claim 1, wherein the alkyl polyglycoside is represented by the formula (I-1) 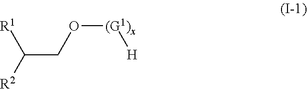
in which
R¹ is a C₁-C₄-alkyl group or hydrogen;
R² is a C₁-C₆-alkyl group or hydrogen;
G¹ is defined as in the formula (I);
x is defined as in the formula (I); and
R¹ and R² are not simultaneously hydrogen, and when one of R¹ and R² is hydrogen, the other of R¹ and R² is a branched alkyl group.

3. The herbicidal composition according to claim 2, wherein R² is —CH₂CH₂—R³, wherein R³ is a linear or branched C₁-C₄ alkyl group or hydrogen.

4. The herbicidal composition according to claim 2, wherein R¹ is methyl, ethyl, n-propyl, isopropyl, n-butyl, isobutyl, or sec-butyl.

5. The herbicidal composition according to claim 1, wherein the monosaccharide referred to as reducing sugar is at least one selected from the group consisting of glucose, mannose, galactose, arabinose, xylose, and ribose.

6. The herbicidal composition according to claim 1, wherein the alkyl polyglycoside is selected from the group consisting of 2-ethylhexyl polyglycoside and 2-propylheptyl polyglycoside.

7. The herbicidal composition according to claim 1, wherein the alkyl polyglycoside component b) further contains an alkylpolyglycoside represented by formula of (II), 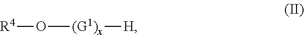
wherein
R⁴ is a linear alkyl having from 3 to 20 carbon atoms and
G¹ and x are as defined for the formula (I).

8. The herbicidal composition according to claim 1, wherein the herbicide is selected from the group consisting of acetamides, amino acid analogs, amides, aryloxyphenoxypropionates, benzamides, benzofurans, benzoic acids, benzothiadiazinones, bipyridyls, carbamates and thiocarbamates, chloroacetamides, chlorocarboxylic acids, cyclohexanediones, dinitroanilines, dinitrophenols, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazines pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, triazines, triazinones, triazoles, triazolinones, triazolocarboxamides, triazolopyrimidines, triketones, uracils, ureas, salts thereof, ammonium salts thereof, sodium salts thereof, potassium salts thereof, alkyl amine salts thereof, and combinations thereof.

9. The herbicidal composition according to claim 1, wherein the herbicide is selected from the group consisting of
amino acid analogs: bilanafos, glyphosate, glufosinate, sulfosate;
carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate;
bipyridyls: diquat, paraquat;
benzothiadiazinones: bentazones;
phenoxyacetic acids: 2,4-dichlorophenoxyacetic acid (2,4-D), 2,4-DB; and
benzoic acids: dicamba;
salts thereof, ammonium salts thereof, sodium salts thereof, potassium salts thereof, alkyl amine salts thereof, and combinations thereof.

10. The herbicidal composition according to claim 1, wherein the herbicide is selected from the group consisting of acifluorfen-sodium, asulam, bentazone, bilanafos, bispyribac-sodium, bromoxynil, clopyralid, 2,4-D, 2,4-DB-potassium, difenzoquat metilsulfate, dicamba, diquat dibromide, fomesafen, glyphosate, glufosinate-ammonium, hexazinone, imazamox, imazapic, imazapyr, imazaquin, imazethapyr, MCPA, MCPB, mecoprop, mecoprop-P, mefluidide, paraquat dichloride, phenmedipham, picloram-potassium, pyrithiobac-sodium, simetryn, aminopyralid, benazolin, dichlorprop, fenoxaprop, flumiclorac, imazamethabenz, ioxynil, naptalam, quinclorac, and combinations thereof.

11. The herbicidal composition according to claim 1, wherein the herbicide is selected from the group consisting of glyphosate, glufosinate, asulam, diquat, paraquat, 2,4-D, dicamba, and bentazones, salts thereof, ammonium salts thereof, sodium salts thereof, potassium salts thereof, alkyl amine salts thereof, and combinations thereof.

12. The herbicidal composition according to claim 1, wherein the herbicidal composition is free of or essentially free of C₈-C₁₆-alkyl ether sulfates.

13. The herbicidal composition according to claim 1, wherein the herbicidal composition is free of or essentially free of alkyl ether sulfates.

14. The herbicidal composition according to claim 1, wherein the alkyl polyglycoside component b) is present in an amount ranging from 0.5 to 85% by weight, based on the total weight of the herbicidal composition.

15. The herbicidal composition according to claim 1, wherein the alkyl polyglycoside component b) contains from 60 to 100% by weight of alkyl polyglycoside of the formula (I), based on the total weight of the alkyl polyglycoside component b).

16. The herbicidal composition according to claim 1, wherein the weight ratio of the herbicide component a) to the alkyl polyglycoside component b) is in the range of from 1:500 to 500:1.

17. A method for preparing the herbicidal composition according to claim 1, comprising mixing the components of the herbicidal composition.

18. A method of using the herbicidal composition according to claim 1, the method comprising using the herbicidal composition for controlling harmful plants.

19. The herbicidal composition according to claim 2, wherein R¹ is ethyl or n-propyl.

20. The herbicidal composition according to claim 1, wherein the alkyl polyglycoside is 2-ethylhexyl polyglycoside.
